(19) United States
(12) Patent Application Publication
(10) Pub. No.: US 2025/0385046 A1
(43) Pub. Date: Dec. 18, 2025

(54) MULTILAYER CERAMIC CAPACITOR

(71) Applicant: Murata Manufacturing Co., Ltd., Nagaokakyo-shi (JP)

(72) Inventors: Hiroyuki WADA, Nagaokakyo-shi (JP); Kosuke URATANI, Nagaokakyo-shi (JP); Kenji UENO, Nagaokakyo-shi (JP)

(21) Appl. No.: 19/192,613

(22) Filed: Apr. 29, 2025

(30) Foreign Application Priority Data
Jun. 17, 2024 (JP) 2024-097411

(51) Int. Cl. H01G 4/12; H01G 4/008; H01G 4/012; H01G 4/30

(52) U.S. Cl. CPC H01G 4/1227; H01G 4/008; H01G 4/012; H01G 4/30

(57) ABSTRACT

A multilayer ceramic capacitor includes an inner-layer portion, first and second outer-layer portions, and first and second side margin portions. Dielectric particles of each of ceramic dielectrics of the inner-layer portion, and the first and second side margin portions include a void. An intragranular void density in a middle portion of the inner-layer portion (inner-layer middle portion) (N [inner-layer middle portion]) and intragranular void densities in the first and second side margin portions (N [side margin portion]) satisfy N [inner-layer middle portion]<N [side margin portion]. A D50 diameter of dielectric particles in an end portion of the inner-layer portion (inner-layer W-end portion) (D5 [(inner-layer W-end portion) and a D50 diameter of dielectric particles in a middle portion of the inner-layer portion (inner-layer middle portion) (D50 [inner-layer middle portion]) satisfy about 1.00≤D50 [inner-layer W-end portion]/D50 [inner-layer middle portion]≤about 1.40.

### CROSS REFERENCE TO RELATED APPLICATIONS

This application claims the benefit of priority to Japanese Patent Application No. 2024-097411 filed on Jun. 17, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

As electronic devices, typically mobile phones, become smaller and CPUs become faster, the need for multilayer ceramic capacitors (MLCCs) has been increasingly growing. A multilayer ceramic capacitor includes dielectric layers with a high dielectric constant formed as thin layers. A multilayer ceramic capacitor, therefore, has a large electrostatic capacitance despite being compact. Multilayer ceramic capacitors made with various materials are known, but ones made using ceramic dielectrics, such as barium titanate (BaTio₃), in the dielectric layers and non-precious metals, such as nickel (Ni), in inner electrode layers are commonly used because they are inexpensive and exhibit high characteristics.

A multilayer ceramic capacitor includes an inner-layer portion, in which dielectric layers formed of a ceramic dielectric and inner electrode layers are alternately stacked, outer-layer portions, which cover the top and bottom of the inner-layer portion, and side margin portions, which cover the inner-layer portion and the outer-layer portions in the width direction. The inner-layer portion defines and functions as a capacitive element. The outer-layer portions and the side margin portions are regions including no inner electrode layer that are provided around the inner-layer portion. These portions can be regarded as acting to protect the inner-layer portion, which defines and functions as a capacitive element, from the external environment.

For multilayer ceramic capacitors, there is a need to increase their electrostatic capacitance per unit volume (volumetric capacitance) and heighten their rated voltage at the same time. To increase the volumetric capacitance, it is effective to reduce the thickness of each of the dielectric layers and the inner electrode layers and maximize the number of stacked layers so that an electrically parallel connection is achieved, or to include numerous layers in the capacitor. In addition to this, it is also effective to reduce the volume of the outer-layer portions, the side margin portions, and extended portions of the inner electrodes, among the components of the multilayer ceramic capacitor. This makes the volume of the inner-layer portion, which defines and functions as a capacitive element, relatively large, thus allowing the volumetric capacitance to be increased.

Ceramic dielectrics used in multilayer ceramic capacitors are produced by firing dielectric powders, such as BaTiO₃ powders. The dielectric powders are synthesized using a method such as the solid-phase method, the hydrothermal method, the sol-gel method, the alkoxide hydrolysis method, the solvothermal method, or the oxalate method. Of these, the hydrothermal method (hydrothermal synthesis) is a method in which a high-temperature and high-pressure aqueous solution is used to synthesize an inorganic powder and provides the advantage that fine powders with uniform particle size can be manufactured at a relatively low cost. Manufacturing a multilayer ceramic capacitor using dielectric powders synthesized by the hydrothermal method (hydrothermally synthesized powders), therefore, allows for reducing the thickness of the dielectric layers and increasing their capacitance. Variations in the diameter of dielectric particles, furthermore, are reduced, which allows for improved a dielectric constant and reliability.

In the hydrothermal method, hydroxides are used as raw materials. For example, a Ba source, such as barium hydroxide (Ba(OH)₂), and a Ti source, such as a metatitanate (TiO(OH)₂) or titanium oxide (TiO₂), are allowed to react in high-temperature and high-pressure water, and the resulting reaction product is subjected to heat treatment to give a BaTiO₃ powder. The OH groups include in the hydroxides the raw materials during the heat treatment, but as a result of this, voids are created inside the particles of the dielectric powder (intragranular voids). Manufacturing a multilayer ceramic capacitor using dielectric powders having intragranular voids, furthermore, results in the intragranular voids remaining in the finished capacitor. When dielectric powders synthesized by methods other than the hydrothermal method are used, in contrast, no intragranular voids are created.

In Japanese Unexamined Patent Application Publication No. 2019-102655, the use of a hydrothermally synthesized powder in the dielectric layers of a multilayer ceramic capacitor is disclosed. Specifically, a method for manufacturing a ceramic capacitor is disclosed that includes a production step in which green sheets are produced using a ceramic slurry including a first ceramic powder synthesized by the hydrothermal method and a second ceramic powder synthesized by a method other than the hydrothermal method and a step of firing the resulting green sheets (see, for example, claim 5 of Japanese Unexamined Patent Application Publication No. 2019-102655). In Japanese Unexamined Patent Application Publication No. 2019-102655, furthermore, it is also stated that pores (voids) present within the ceramic particles alleviate piezoelectric strain, which leads to the reduction of cracks (of Japanese Unexamined Patent Application Publication No. 2019-102655).

With advances in electronic components and electronic devices, further reduction in the size and further increase in the capacitance of multilayer ceramic capacitors have been anticipated. As the scope of use of multilayer ceramic capacitors expands, furthermore, the demand for improvements in their reliability has been increasingly growing. As a result, the development of a multilayer ceramic capacitor that has little degradation of insulation resistance and is superior in reliability despite further reduced layer thickness is in demand. The technologies that have hitherto been proposed are effective to some extent, but they still require improvement.

The inventors of example embodiments of the present invention conducted extensive research in light of such problems. The inventors of example embodiments of the present invention discovered that a multilayer ceramic capacitor with reduced insulation resistance degradation and high reliability can be obtained by introducing internal voids into the dielectric particles in the inner-layer portion and side margin portions of the multilayer ceramic capacitor and controlling proportions of internal voids and D50 diameters of dielectric particles.

### SUMMARY OF THE INVENTION

Example embodiments of the present invention provide multilayer ceramic capacitors with reduced insulation resistance degradation and high reliability.

It should be noted that a range expressed using “from” and “to” herein includes the values at both ends. That is, “from X to Y” is synonymous with “X or more and Y or less.”

According to an example embodiment of the present invention, a multilayer ceramic capacitor includes an inner-layer portion including at least one first inner electrode layer and at least one second inner electrode layer alternately stacked with at least one dielectric layer including a ceramic dielectric interposed therebetween, a first primary surface facing a stacking direction, a second primary surface opposite to the first primary surface, a first side surface facing a width direction orthogonal or substantially orthogonal to the first primary surface and the second primary surface, and to which the first inner electrode layer and the second inner electrode layer are extended, a second side surface opposite to the first side surface and to which the first inner electrode layer and the second inner electrode layer are extended, a first end surface facing a length direction orthogonal or substantially orthogonal to the first primary surface, the second primary surface, the first side surface, and the second side surface, and to which the first inner electrode layer is extended, and a second end surface opposite to the first end surface and to which the second inner electrode layer is extended, a first outer-layer portion including a ceramic dielectric and covering the first primary surface in the stacking direction, a second outer-layer portion including a ceramic dielectric and coverings the second primary surface in the stacking direction, a first side margin portion including a ceramic dielectric and covering the inner-layer portion, the first outer-layer portion, and the second outer-layer portion from one side in the width direction, a second side margin portion including a ceramic dielectric and covering the inner-layer portion, the first outer-layer portion, and the second outer-layer portion from another side in the width direction, and a pair of outer electrodes on the first end surface and the second end surface and coupled to each of the first inner electrode layer and the second inner electrode layer, wherein dielectric particles of each of the ceramic dielectrics of the inner-layer portion, the first side margin portion, and the second side margin portion include dielectric particles including a void therein, an intragranular void density in a middle portion of the inner-layer portion or an inner-layer middle portion defined as N [inner-layer middle portion], and intragranular void densities in the first side margin portion and the second side margin portion, defined as N [side margin portion], satisfy a relationship of N [inner-layer middle portion]<N [side margin portion], and a D50 diameter of dielectric particles in an end portion in the width direction of the inner-layer portion, or an inner-layer W-end portion, defined as D50 [inner-layer W-end portion], and a D50 diameter of dielectric particles in the middle portion of the inner-layer portion, or the inner-layer middle portion, defined as D50 [inner-layer middle portion], satisfy a relationship of about 1.00≤D50 [inner-layer W-end portion]/D50 [inner-layer middle portion]≤ about 1.40.

According to example embodiments of the present invention, multilayer ceramic capacitors each with reduced insulation resistance degradation and high reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating the external shape of a multilayer ceramic capacitor according to an example embodiment of the present invention.

FIG. 2 is a cross-sectional view schematically illustrating the internal structure of a multilayer ceramic capacitor according to an example embodiment of the present invention.

FIG. 3 is a cross-sectional view schematically illustrating the internal structure of a multilayer ceramic capacitor according to an example embodiment of the present invention.

FIGS. 4A and 4B are diagrams used to describe an inner-layer middle portion and an inner-layer W-end portion.

FIGS. 5A and 5B are diagrams illustrating a distribution of intragranular voids in a dielectric layer.

FIGS. 6A and 6B are diagrams used to describe a measurement of an incidence rate of polarity IR.

FIGS. 7A and 7B are diagrams used to describe a flexural test.

### DETAILED DESCRIPTION OF THE EXAMPLE EMBODIMENTS

Example embodiments of the present invention will be described in detail below with reference to the drawings. The present invention is not limited to the following example embodiments, and various modifications are possible within the gist and scope of the present invention.

### 1. Multilayer Ceramic Capacitor

A multilayer ceramic capacitor according to an example embodiment of the present invention includes an inner-layer portion, a first outer-layer portion, a second outer-layer portion, a first side margin portion, a second side margin portion, and a pair of outer electrodes. The inner-layer portion is a region in which first inner electrode layers and second inner electrode layers are alternately stacked with dielectric layers including a ceramic dielectric interposed therebetween. The inner-layer portion includes a first primary surface and a second primary surface, a first side surface and a second side surface, and a first end surface and a second end surface. The first primary surface is a surface facing the direction in which the dielectric layers, the first inner electrode layers, and the second electrode layers are stacked. The second primary surface is a surface opposite to the first primary surface. The first side surface is a surface facing the width direction orthogonal or substantially orthogonal to the first primary surface and the second primary surface. The second side surface is a surface opposite to the first side surface. The first end surface is a surface facing the length direction orthogonal or substantially orthogonal to the first primary surface, the second primary surface, the first side surface, and the second side surface, and to which the first inner electrode layers are extended. The second end surface is a surface opposite to the first end surface and to which the second inner electrode layers are extended. The first outer-layer portion includes a ceramic dielectric and covers the first primary surface in the stacking direction. The second outer-layer portion includes a ceramic dielectric and covers the second primary surface in the stacking direction. The first side margin portion includes a ceramic dielectric and covers the inner-layer portion, the first outer-layer portion, and the second outer-layer portion from one side in the width direction. The second side margin portion includes a ceramic dielectric and covers the inner-layer portion, the first outer-layer portion, and the second outer-layer portion from the other side in the width direction. The pair of outer electrodes are provided on the first end surface and the second end surface and coupled to either the first inner electrode layers or the second inner electrode layers. The dielectric particles of each of the ceramic dielectrics of the inner-layer portion, the first side margin portion, and the second side margin portion include dielectric particles including a void therein. The intragranular void density in the middle portion of the inner-layer portion (N [inner-layer middle portion]) and the intragranular void densities in the first side margin portion and the second side margin portion (N [side margin portion]) satisfy the relationship of the formula: N [inner-layer middle portion]<N [side margin portion]. The D50 diameter of dielectric particles in the end portion in the width direction of the inner-layer portion (inner-layer W-end portion) (D50 [inner-layer W-end portion]) and the D50 diameter of dielectric particles in the middle portion of the inner-layer portion (inner-layer middle portion) (D50 [inner-layer middle portion]) satisfy the relationship of the formula: about 1.00≤D50 [inner-layer W-end portion]/D50 [inner-layer middle portion]≤about 1.40.

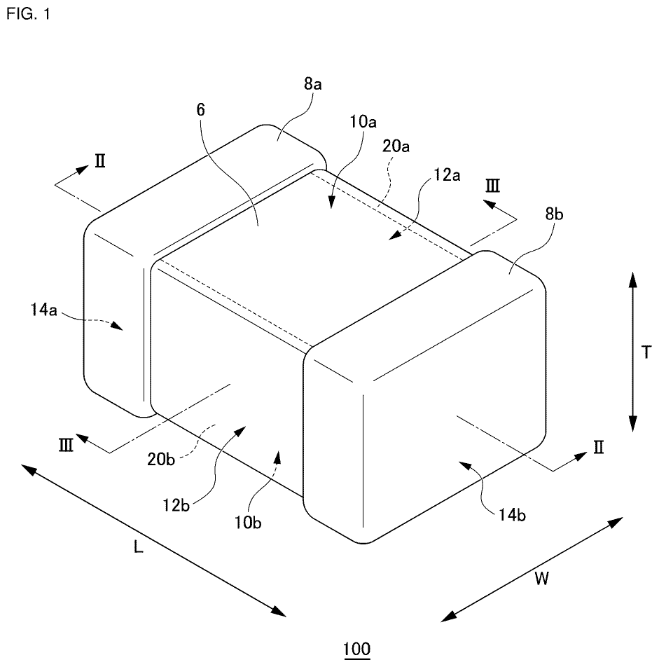

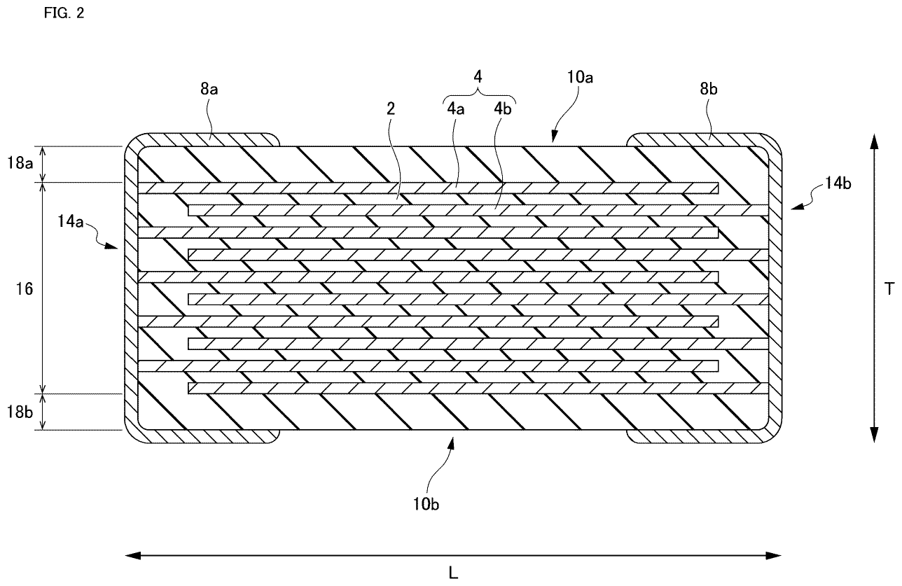

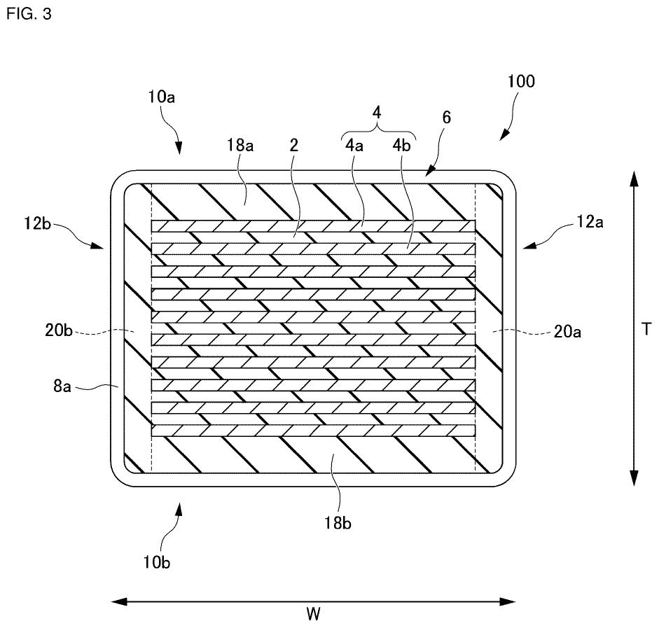

A form of a multilayer ceramic capacitor will be described using FIGS. 1 to 3. FIG. 1 is a perspective view illustrating the external shape of the multilayer ceramic capacitor. FIG. 2 is a cross-section of the multilayer ceramic capacitor illustrated in FIG. 1 taken along line II-II, and FIG. 3 is a cross-sectional view of the multilayer ceramic capacitor illustrated in FIG. 1 taken along line III-III.

The multilayer ceramic capacitor 100 includes a body portion 6 and a pair of outer electrodes 8a and 8b provided on both end surfaces 14a and 14b of this body portion 6. The multilayer ceramic capacitor 100 and the body portion 6 have a rectangular or substantially rectangular parallelepiped shape. A substantially rectangular parallelepiped encompasses not only a rectangular parallelepiped but also a rectangular parallelepiped whose corner portions and/or edge portions are rounded.

The multilayer ceramic capacitor 100 and the body portion 6 include a first outer primary surface 10a and a second outer primary surface 10b facing each other in the thickness direction T, a first outer side surface 12a and a second outer side surface 12b facing each other in the width direction W, and a first outer end surface 14a and a second outer end surface 14b facing each other in the length direction L. In this context, the thickness direction T is the direction in which dielectric layers 2 and inner electrode layers 4, include in the body portion 6, are stacked. The length direction L is the direction that is orthogonal or substantially orthogonal to the thickness direction T and in which the outer end surfaces 14a and 14b are opposite each other. The width direction W is the direction orthogonal or substantially orthogonal to the thickness direction T and the length direction L. A plane including the thickness direction T and the width direction W is defined as a WT plane, a plane including the width direction W and the length direction L is defined as an LW plane, and a plane including the length direction L and the thickness direction T is defined as an LT plane.

The body portion 6 includes an inner-layer portion 16, a first outer-layer portion 18a, a second outer-layer portion 18b, a first side margin portion 20a, and a second side margin portion 20b.

The inner-layer portion 16 is a region in which inner electrode layers 4 are alternately stacked with dielectric layers 2 interposed therebetween. The dielectric layers 2 include a ceramic dielectric. The inner electrode layers 4 include multiple first inner electrode layers 4a and multiple second inner electrode layers 4b.

The inner-layer portion 16 includes a first primary surface, a second primary surface, a first side surface, a second side surface, a first end surface, and a second end surface. The first primary surface is a surface perpendicular or substantially perpendicular to the direction in which the dielectric layers 2 and the inner electrode layers 4a and 4b are stacked. The second primary surface is the surface opposite (the surface facing) to the first primary surface. The first side surface is a surface orthogonal or substantially orthogonal to the first primary surface and the second primary surface, i.e., a surface perpendicular or substantially perpendicular to the width direction W. The second side surface is the surface opposite (the surface facing) to the first side surface. The first end surface is a surface orthogonal or substantially orthogonal to the first primary surface, the second primary surface, the first side surface, and the second side surface, i.e., a surface perpendicular or substantially perpendicular to the length direction L. The second end surface is the surface opposite (the surface facing) to the first end surface. To the first side surface and the second side surface, the inner electrode layers 4a and 4b are extended. In other words, on both of the first side surface side and the second side surface side, end portions of the inner electrode layers are exposed. To the first end surface, the first inner electrode layers 4a are extended, but the second inner electrode layers 4b are not extended. To the second end surface, the second inner electrode layers 4b are extended, but the first inner electrode layers 4a are not extended.

The first outer-layer portion 18a is a region that covers the first primary surface of the inner-layer portion 16 in the stacking direction (thickness direction T). The second outer-layer portion 18b is a region that covers the second primary surface of the inner-layer portion 16 in the stacking direction. The first side margin portion 20a is a region that covers the inner-layer portion 16, the first outer-layer portion 18a, and the second outer-layer portion 18b from one side in the width direction (first side surface side). The second side margin portion 20a is a region that covers the inner-layer portion 16, the first outer-layer portion 18a, and the second outer-layer portion 18b from the other side in the width direction (second side surface side). The first outer-layer portion 18a, the second outer-layer portion 18b, the first side margin portion 20a, and the second side margin portion 20b include ceramic dielectrics.

The outer electrodes 8a and 8b include a first outer electrode 8a provided on the first outer end surface 14a of the body portion 6 and a second outer electrode 8b provided on the second outer end surface 14b. The first outer electrode 8a and the second outer electrode 8b are not in contact with each other, and they are electrically separated.

The sizes of the multilayer ceramic capacitor 100 and the body portion 6 are not particularly limited. For example, the dimension in the length direction L is about 0.2 mm or more and about 3.2 mm or less, the dimension in the width direction W is about 0.1 mm or more and about 2.5 mm or less, and the dimension in the stacking direction T is about 0.1 mm or more and about 2.5 mm or less. Although in FIGS. 1 to 3 the multilayer ceramic capacitor is illustrated such that the dimension in the length direction L is greater than the dimension in the width direction W, the multilayer ceramic capacitor according to the present example embodiment is not limited to ones having such dimensions. The dimension in the length direction L may be smaller than the dimension in the width direction W.

### Inner-Layer Portion: Dielectric Layers

The inner-layer portion is a region in which inner electrode layers (first inner electrode layers and second inner electrode layers) are alternately stacked with dielectric layers including a ceramic dielectric interposed therebetween. The dielectric layers include a ceramic dielectric produced by firing inner-layer green sheets, which include a dielectric raw material. The ceramic dielectric is based on a sintered polycrystal (ceramic) in which numerous dielectric particles are bound together with grain boundaries and triple points interposed therebetween. In other words, the ceramic dielectric includes dielectric particles (dielectric grains) as its primary component. The primary component is the component with the highest percentage, or the component present at about 50% by mass or more, for example, in the ceramic dielectric.

The dielectric particles include, for example, a perovskite oxide. A perovskite oxide has a composition represented by the general formula: ABO₃, and has a cubic crystal structure, such as cubic, tetragonal, orthorhombic, or rhombohedral, at room temperature. Each of the atoms of the A-site element (hereinafter “A-site atoms”) and the atoms of the B-site element (hereinafter “B-site atoms”), furthermore, becomes ionized and occupies the A-site or B-site in the perovskite structure. Examples of A-site elements include elements with relatively large ionic sizes, such as barium (Ba), calcium (Ca), or strontium (Sr), and examples of B-site elements include elements with relatively small ionic sizes, such as titanium (Ti), zirconium (Zr), or hafnium (Hf). The combination of the A-site element and the B-site element is not particularly limited, as long as the perovskite structure is maintained. Each of the A-site element and the B-site element may include only one element or may alternatively include multiple elements in combination. Moreover, as long as the perovskite structure is maintained, the molar ratio between the A-site element and the B-site element may deviate from 1:1.

Specific examples of perovskite oxides include barium titanate (BaTiO₃) compounds, calcium titanate (CaTiO₃) compounds, strontium titanate (SrTiO₃) compounds, or their mixed crystals and solid solutions. Preferably, the A-site element includes barium (Ba) with the B-site element including titanium (Ti), for example. That is, for example, the perovskite oxide is preferably a barium titanate (BaTiO₃) compound. BaTiO₃ compounds have a high dielectric constant. BaTiO₃ compounds, therefore, are particularly suitable for increasing the capacitance of multilayer ceramic capacitors. BaTiO₃ compounds encompass not only BaTiO₃ but also compounds in which a portion of the Ba in BaTio₃ has been replaced with other A-site elements, such as Sr and/or Ca, for example, or compounds in which a portion of the Ti in BaTio₃ has been replaced with other B-site elements, such as Zr and/or Hf, for example.

The ceramic dielectric may include secondary components. Examples of secondary components include rare earth elements (REs), magnesium (Mg), manganese (Mn), iron (Fe), chromium (Cr), cobalt (Co), nickel (Ni), silicon (Si), aluminum (Al), vanadium (V), or their compounds, although not limited. For rare earth elements (REs), for example, dysprosium (Dy) may preferably be used. The ceramic dielectric may include one such component alone as a secondary component or may include multiple components in combination. The form in which the secondary components exist is not limited. The secondary components may only be included in any of the dielectric particles, grain boundaries, or triple points.

The dielectric particles may include core-shell particles. A core-shell particle refers to a particle having a structure in which at least a subset of secondary components is dissolved at high concentrations in the surface layer (shell portion) of the particle, with the secondary components being dissolved at low concentrations or the secondary components not dissolved in the middle portion (core portion) of the particle (core-shell structure). Alternatively, the dielectric particles may include dielectric particles in which secondary components are dissolved throughout the inside of the particles.

The thickness of the dielectric layers occupying the inner-layer portion is, for example, preferably about 0.6 μm or more and about 3.0 μm or less. Setting the thickness of the dielectric layers equal to or greater than a predetermined value allows for reducing the occurrence of dielectric breakdown during the use of the multilayer ceramic capacitor and service life degradation. Setting the thickness of the dielectric layers equal to or smaller than a predetermined value, furthermore, allows for further increasing the capacitance of the multilayer ceramic capacitor because the dielectric layers are formed as thin layers. The number of dielectric layers is not particularly limited. Preferably, for example, the number of dielectric layers constituting the inner-layer portion is 100 or more and 2000 or fewer.

### Inner-Layer Portion: Inner Electrode Layers

The inner electrode layers (the first inner electrode layers and the second inner electrode layers) include a facing electrode portion and an extended electrode portion and define the inner-layer portion together with the dielectric layers. The facing electrode portion allows the dielectric layers to exhibit their function as capacitive elements by sandwiching them. The extended electrode portion acts to electrically couple the facing electrode portion and the outer electrodes. The inner electrode layers include at least one conductive metal. The conductive metal can be any one or more known electrode materials, such as nickel (Ni), copper (Cu), silver (Ag), palladium (Pd), a silver (Ag)-palladium (Pd) alloy, and/or gold (Au). The inner electrode layers are produced by sintering conductive paste layers formed on the surface of inner-layer green sheets by printing.

The inner electrode layers may include additional components, other than the conductive metal. An example of an additional component is a ceramic component that acts as a common material. The thickness of the inner electrode layers, furthermore, is, for example, preferably about 0.40 μm or more and about 1.5 μm or less. By setting the thickness of the inner electrodes equal to or greater than a predetermined value, the occurrence of problems such as broken electrodes can be prevented. By setting the thickness equal to or smaller than a predetermined value, furthermore, a decrease in the percentage that the dielectric layers defining in the capacitor can be prevented, contributing to increasing the capacitance. Moreover, the number of inner electrode layers is, for example, preferably 100 or more and 2000 or fewer.

### Outer-Layer Portions

The outer-layer portions (the first outer-layer portion and the second outer-layer portion) are provided above and below the inner-layer portion, one on each side. The outer-layer portions are regions include ceramic dielectrics and no inner electrode layer therein. The outer-layer portions are produced by firing outer-layer green sheets, which include a dielectric raw material.

### Side Margin Portions

The side margin portions (the first side margin portion and the second side margin portion) are provided along the side surfaces of the multilayer ceramic capacitor to sandwich the inner-layer portion and the outer-layer portions. The side margin portions are also referred to as the side gap portions or side portions. The side margin portions are regions including ceramic dielectrics and no inner electrode layer therein. By providing the side margin portions, the penetration of water into the inner-layer portion through the side surfaces can be prevented.

The side margin portions are formed separately from the inner-layer portion and the outer-layer portions during the manufacture of the multilayer ceramic capacitor. Specifically, the multilayer ceramic capacitor can be manufactured by producing a green body portion by attaching side-margin green bodies to the side surfaces of a multilayer chip, which will become the inner-layer portion and the outer-layer portions, and firing this green body portion. In that case, the ceramic dielectrics of the side margin portions may have a composition and/or a microscopic structure discontinuous with those of the ceramic dielectric(s) of the inner-layer portion and/or the outer-layer portions. Between the side margin portions and the inner-layer portion and/or the outer-layer portions, therefore, physical or chemical boundaries may exist.

### Outer Electrodes

The outer electrodes (the first outer electrode and the second outer electrode) define input/output terminals of the multilayer ceramic capacitor. The first outer electrode and the second outer electrode are provided on both end surfaces of the multilayer ceramic capacitor. The first outer electrode is coupled to the first inner electrode layers, and the second outer electrode is coupled to the second inner electrode layers. For the outer electrodes, known configurations can be used. For example, the outer electrodes may include a base electrode layer and a plating layer disposed thereon. Alternatively, the outer electrodes may include only a plating layer, without providing a base electrode layer.

### Intragranular Void Densities

In the multilayer ceramic capacitor according to the present example embodiment, each of the ceramic dielectrics of the inner-layer portion, the first side margin portion, and the second side margin portion includes dielectric particles including a void therein (an intragranular void). That is, an intragranular void exists in at least a subset of the dielectric particles of the ceramic dielectric. In this context, an intragranular void is a void present inside a dielectric particle. In other words, an intragranular void is a region present inside a dielectric particle and including no solid component, such as the primary component of the dielectric particle or intentionally added secondary components. An intragranular void, therefore, is distinguished from an extragranular void, which is present at a boundary or triple point between particles. A dielectric particle including a void therein is referred to as a voided particle. A ceramic dielectric including such voided particles is produced from a hydrothermally synthesized powder.

By incorporating voided particles in the ceramic dielectric of the inner-layer portion (hereinafter also collectively referred to as “the inner-layer ceramic”), an improvement in reliability can be provided by reducing insulation resistance (IR) degradation in the multilayer ceramic capacitor. Although not to be construed as limiting, the inventors of example embodiments of the present invention consider the following to be a reason for this.

When the numbers of dielectric layers and inner electrode layers are increased to raise the electrostatic capacitance per unit volume, or the volumetric capacitance, the area of the interfaces present between these layers increases. Once the smoothness of these interfaces is impaired, it is likely that the IR is degraded upon voltage application as a result of the concentration of an electric field. Achieving a high rated voltage of the multilayer ceramic capacitor, therefore, becomes difficult. A hydrothermally synthesized powder, however, has a nearly spherical shape. When it is used, therefore, the interfaces between the dielectric layers and the inner electrodes are smoothed at the pre-firing stage, and this state is maintained even after firing. It is, therefore, preferable to use a hydrothermally synthesized powder as a raw material for the dielectric layers in the inner-layer portion, and it is particularly preferable to use a hydrothermally synthesized powder including a BaTio₃ compound, which exhibits a high dielectric constant, as its primary component. Using a hydrothermally synthesized powder results in the formation of voided particles in the ceramic dielectric.

Including voided particles in the ceramic dielectrics of the side margin portions (the first side margin portion and the second side margin portion) (hereinafter also collectively referred to as “the side-margin ceramics”), furthermore, allows for an improvement in volumetric capacitance and a further reduction in IR degradation. Although not to be construed as limiting, the inventors of example embodiments of the present invention consider the following to be a reason for this.

To increase the volumetric capacitance of a multilayer ceramic capacitor, it is effective to reduce the thickness of the side margin portions in the width (W) direction. By using a process in which a precursor to the inner-layer portion and a precursor to the side margin portions are prepared separately, the precursors are bonded together, and then fired to form a one-piece structure, furthermore, such a multilayer ceramic capacitor can be manufactured easily. In this process, for example, it is preferable to use a hydrothermally synthesized powder, a hydrothermally synthesized powder including the same BaTiO₃ compound as the inner-layer portion as its primary component in particular, as a raw material for the side margin portions. This is because a hydrothermally synthesized powder has high flowability. Using this type of powder, therefore, allows the adhesion between the precursor to the side margins and the precursor to the inner-layer portion to be increased, and this leads to reduced IR degradation.

As stated earlier, it is known that using hydrothermally synthesized powders in the inner-layer portion and the side margin portions leads to reduced IR degradation. In addition to this, the inventors of example embodiments of the present invention conducted extensive research from the viewpoint of reducing IR degradation, finding a relationship that allows for better reduction of IR degradation by appropriately controlling the densities of intragranular voids left in the fired inner-layer portion and side margin portions. Specifically, the finding is that, in the multilayer ceramic capacitor according to the present example embodiment, the intragranular void density in the middle portion of the inner-layer portion (inner-layer middle portion) (N [inner-layer middle portion]) and the intragranular void densities in the side margin portions (the first side margin portion and the second side margin portion) (N [side margin portion]) satisfy the relationship of the formula: N [inner-layer middle portion]<N [side margin portion]. That is, the finding is to control the ceramic structure to achieve the relationship of the intragranular void densities in the ceramic dielectrics in the side margin portions being greater than the intragranular void density in the ceramic dielectric in the inner-layer middle portion. The inner-layer middle portion is a region that occupies the vicinity of the center of the inner-layer portion and is defined by the method described later. An intragranular void density, furthermore, is the number of intragranular voids per unit area in a cross-section that passes through the middle portion in the length direction (WT plane) of the multilayer ceramic capacitor and is measured by the method described later.

The inventors of example embodiments of the present invention experimentally discovered that controlling the intragranular void densities in the inner-layer middle portion and the side margin portions to satisfy the relationship specified above allows for more effective reduction of insulation resistance (IR) degradation.

In the multilayer ceramic capacitor according to the present example embodiment, for example, the D50 diameter of dielectric particles in the end portion in the width direction of the inner-layer portion (inner-layer W-end portion) (D50 [inner-layer W-end portion]) and the D50 diameter of dielectric particles in the middle portion of the inner-layer portion (inner-layer middle portion) (D50 [inner-layer middle portion]) satisfy the relationship of the formula: about 1.00≤D50 [inner-layer W-end portion]/D50 [inner-layer middle portion]≤about 1.40. That is, the difference between the D50 diameter of dielectric particles in the inner-layer middle portion and the D50 diameter of dielectric particles in the inner-layer W-end portion is relatively small. This allows for more effective reduction of IR degradation. Although not to be construed as limiting, the inventors of example embodiments of the present invention consider the following to be a reason for this. The inner-layer middle portion is a region that occupies the vicinity of the center of the inner-layer portion, and the inner-layer W-end portion is a region that occupies an end portion in the width (W) direction of the inner-layer portion. These are defined by the methods described later.

As stated earlier, in the inner-layer W-end portion, grain growth is encouraged compared to the inner-layer middle portion. As grain growth proceeds in the inner-layer W-end portion, furthermore, the number of dielectric particles in the direction along the thickness of the dielectric layers decreases, giving rise to IR degradation. When the ratio between the D50 diameter in the inner-layer W-end portion and the D50 diameter in the inner-layer middle portion is controlled to satisfy the relationship specified above, in contrast, the grain growth in the inner-layer W-end portion is limited. As a result, a sufficient number of dielectric particles in the direction along the thickness of the dielectric layers can be maintained, and this leads to reduced IR degradation. From the viewpoint of reducing IR degradation, for example, it is preferable that D50 [inner-layer W-end portion] and D50 [inner-layer middle portion] satisfy the relationship of the formula: about 1.00≤D50 [inner-layer W-end portion]/D50 [inner-layer middle portion]≤about 1.17, more preferably satisfying the relationship of the formula: about 1.00≤D50 [inner-layer W-end portion]/D50 [inner-layer middle portion]≤about 1.06.

As long as D50 [inner-layer middle portion] and D50 [inner-layer W-end portion] satisfy the relationship specified above, their respective values are not limited. By setting the particle diameters adequately large, however, it can be ensured that the particles exhibit sufficient crystallinity, and that the advantages of improved characteristics associated with it are sufficiently produced. By limiting the particle diameters to appropriate levels, on the other hand, further thinning of the dielectric layers can be promoted. D50 [inner-layer middle portion] is, for example, preferably about 150 nm or more and about 360 nm or less. D50 [inner-layer W-end portion] is, for example, preferably about 150 nm or more and about 500 nm or less. The D50 diameters described above (D50 [inner-layer middle portion] and D50 [inner-layer W-end portion]) are the D50 diameters of the entire populations of dielectric particles, including not only voided particles but also particles including no void.

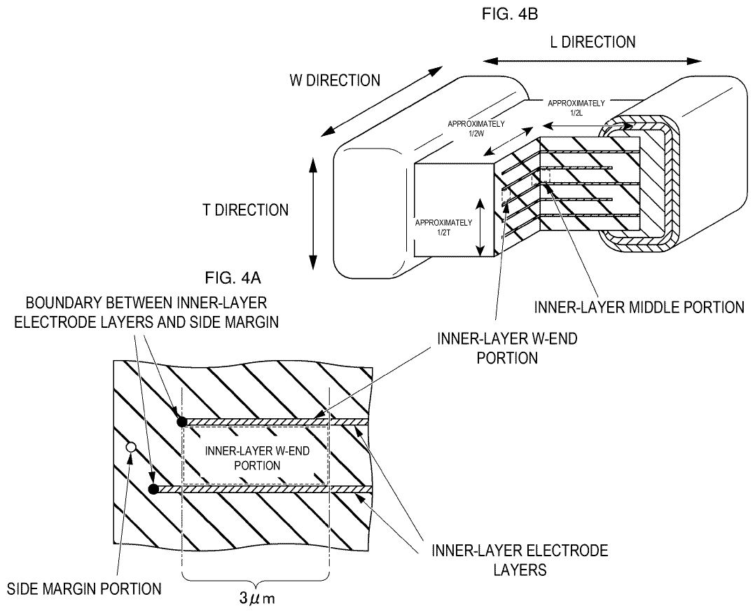

The inner-layer middle portion is defined as follows. In the body portion obtained by removing the outer electrodes from the multilayer ceramic capacitor, a dielectric layer located at approximately ½ the thickness T dimension is designated. In this designated dielectric layer, a region located at approximately ½ the length L dimension and approximately ½ the width W dimension of the body portion is defined as the inner-layer middle portion (FIG. 4A).

The number of intragranular voids in the inner-layer middle portion can be determined through transmission electron microscope (TEM) observation. Specifically, fields of view are selected within a region in the inner-layer middle portion defined by, for example, about 10 μm (W direction)×about 10 μm (L direction)×the thickness of the dielectric layer (T direction), and TEM observation is performed. The D50 diameter of dielectric particles in the inner-layer middle portion (D50 [inner-layer middle portion]), furthermore, can be determined through scanning electron microscope (SEM) observation. Specifically, in a WT plane, a region in the inner-layer middle portion defined by, for example, about 3 μm (W direction)×the thickness of the dielectric layer (T direction) is defined. The diameters of the granular electric particles include in this region are measured, and their average is calculated as D50. The SEM observation may be performed under the conditions of, for example, a magnification of about 25000×. In the particle diameter measurement, furthermore, the diameters of not only voided particles but also of particles including no void are measured.

The inner-layer W-end portion is defined as follows. The dielectric layer designated during the process of defining the inner-layer middle portion is focused on, and a boundary between the inner electrode layers and a side margin portion is defined for this dielectric layer. Specifically, the end portions in the W direction of the pair of inner electrode layers facing each other with the dielectric layer therebetween are defined as the boundary. When the respective end portions of the pair of inner electrode layers are misaligned in the W direction in this process, the end portion in closer proximity to the inner-layer middle portion is chosen as the boundary. Then, with this boundary as the starting point, the portion of the dielectric layer included within a distance of, for example, about 3 μm toward the inner-layer middle portion is defined as the inner-layer W-end portion (FIGS. 4A and 4B).

The number of intragranular voids in the inner-layer W-end portion can be determined through TEM observation of the inner-layer W-end portion. The D50 diameter (D50 [inner-layer W-end portion]) can be determined through SEM observation of the inner-layer W-end portion. The SEM observation may be performed under the conditions of, for example, a magnification of about 25000×. In the particle diameter measurement, furthermore, the diameters of not only voided particles but also of particles including no void are measured.

Preferably, the intragranular void density in the inner-layer middle portion (N [inner-layer middle portion]) is, for example, about 10 voids/μm² or less. By reducing N [inner-layer middle portion], the problem of polarity IR can be mitigated. In this context, polarity IR is a phenomenon in which the value of insulation resistance (IR) changes depending on the direction of the applied voltage (polarity). More specifically, in a multilayer ceramic capacitor, outer electrodes and inner electrodes are coupled together. When the polarity of the voltage applied to the outer electrodes is inverted, therefore, the direction of the voltage applied to the dielectric ceramic in the inner-layer portion becomes inverted. In this process, the value of IR can change with the direction of the voltage. This is referred to as polarity IR. When the polarity IR is too significant to ignore, the value of IR greatly changes depending on the direction in which the multilayer ceramic capacitor is mounted. In actual operation settings, it is preferable to minimize polarity IR because it causes variations in the IR value.

The inventors consider the following to be a reason why polarity IR can be reduced by reducing N [inner-layer middle portion], although this should not be construed as limiting.

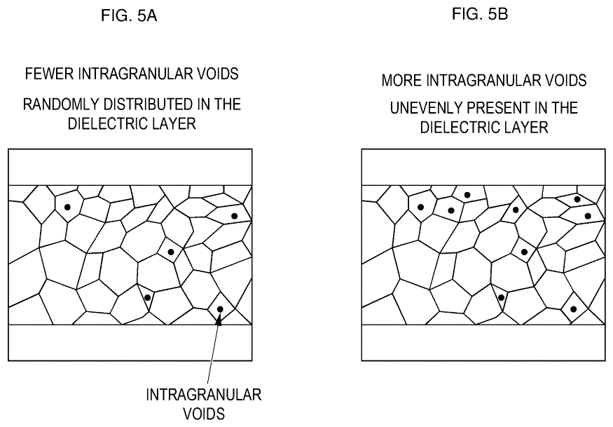

As stated earlier, using a hydrothermally synthesized powder is advantageous in reducing IR degradation because it makes the interfaces between the dielectric layers and the inner electrode layers smooth. When a hydrothermally synthesized powder is used, however, voided particles are left within the dielectric layers. The voids pose no problem if they are located at the point equidistant from both the pair of inner electrodes facing each other with the dielectric layer therebetween. If they are located closer to one electrode than to the other, however, polarity IR occurs. This is because the behavior of the applied electric field changes near the voids, and the distribution of electric field strength changes when the direction of the applied voltage is changed. Voids are more likely to be left within dielectric particles that do not grow during firing. In the dielectric layers (the inner-layer portion), dielectric particles with a small degree of grain growth may be distributed close to each other in some cases (FIG. 5B). Under such a particle diameter distribution of dielectric particles, unevenness also arises in the distribution of intragranular voids. The difference in electric field strength that occurs when the direction of the applied voltage is changed, therefore, becomes significant, causing the occurrence of polarity IR.

When the intragranular void density in the inner-layer middle portion (N [inner-layer middle portion]) is small, by contrast, the voids can be regarded as being randomly distributed (FIG. 5A). In addition, the number of voids themselves is small, which means that the changes in the behavior of the applied electric field near the voids are negligibly small. Polarity IR, therefore, is considerably reduced.

When the thickness of the dielectric layers is, for example, about 3.0 μm or less, it is preferable that N [inner-layer middle portion] is more than 0 voids/μm² and about 10 voids/μm² or less, more preferably more than 0 voids/μm² and about 7 voids/μm² or less, and even more preferably more than 0 voids/μm² and about 4/voids μm² or less, so that the incidence rate of polarity IR is lowered. N [inner-layer middle portion] may be, for example, about 1 void/μm² or more.

The intragranular void densities in the side margin portions (N [side margin portion]), furthermore, are not limited as long as they satisfy the relationship between N [inner-layer middle portion] and N [side margin portion] specified above. For the advantage of reduced IR degradation to be further improved, however, N [side margin portion] is, for example, preferably about 5 voids/μm² or more and about 26 voids/μm² or less, more preferably about 10 voids/μm² or more and about 26 voids/μm² or less, and even more preferably about 15 voids/μm² or more and about 26 voids/μm² or less.

The side margin portions include the first side margin portion and the second side margin portion. The intragranular void density in the first side margin portion and the intragranular void density in the second side margin portion may be the same or may alternatively be different. Preferably, however, both are greater than the intragranular void density in the inner-layer middle portion.

Preferably, the ceramic dielectrics of the outer-layer portions (the first outer-layer portion and the second outer-layer portion) (hereinafter also collectively referred to as “the outer-layer ceramics”) include voided particles. This allows for effective reduction of the formation of cracks in the multilayer ceramic capacitor. Although not to be construed as limiting, the inventors of example embodiments of the present invention consider the following to be a reason for this.

In the firing step during the manufacture of the multilayer ceramic capacitor, the dielectric particles not only in the side margin portions but also in the outer-layer portions are likely to grow compared to those in the inner-layer portion. When grain growth occurs, not only does the D50 diameter of dielectric particles increase, but the particle size distribution also broadens. In a ceramic sintered body, the stress that a given particle receives from adjacent ones is balanced across the entire ceramic body, resulting in the maintenance of high mechanical strength. In a sintered body having a particle size distribution, the number of adjacent particles and the diameters of adjacent particles vary from dielectric particle to dielectric particle. When viewed microscopically, this causes variations in strength. Because of this, cracks are likely to form when the multilayer ceramic capacitor is subjected to a flexural test of the board on which it is mounted.

When internal voids are introduced into the dielectric particles in the outer-layer portions to limit their grain growth and minimize their particle size distribution, in contrast, the microscopic mechanical strength is equalized. As a result, the formation of cracks is effectively reduced.

Preferably, the intragranular void density in the middle portion of the inner-layer portion (inner-layer middle portion) (N [inner-layer middle portion]) and the intragranular void densities in the first outer-layer portion and the second outer-layer portion (N [outer-layer portion]) satisfy the relationship of the formula: N [inner-layer middle portion]<N [outer-layer portion]. This allows for even more substantial reduction of the formation of cracks in the multilayer ceramic capacitor. Although not to be construed as limiting, the inventors of example embodiments of the present invention consider the following to be a reason for this.

When the mounting of the multilayer ceramic capacitor on a printed board is on a vertical board, on which the outer-layer portions (W direction) are perpendicular or substantially perpendicular to the surface of the board, tensile stress is applied to the side margin portions when the board is bent. When the mounting is on a horizontal board, on which the outer-layer portions (W direction) are parallel or substantially parallel to the surface of the board, in contrast, tensile stress is applied to the outer-layer portions when the board is bent. Typically, the direction of mounting is random, which means that the tensile stress caused by the bending of the board is applied to both the outer-layer portions and the side margin portions. When the intragranular void densities in the side margin portions are greater than the intragranular void density in the inner-layer portion with the intragranular void densities in the outer-layer portions being greater than the intragranular void density in the inner-layer portion, the presence of intragranular voids present at relatively high densities ensures that microscopic mechanical strength is equalized. This leads to the prevention of cracks, even when tensile stress is applied to both the side margin portions and the outer-layer portions.

Since the diameters of dielectric particles in which intragranular voids are present are relatively small, the areas of grain boundaries in the side margin portions and the outer-layer portions, which include such dielectric particles, increase. This means an increase in the area of strengthened grain boundaries, and leads to the prevention of cracks from this respect, as well. That is, setting the intragranular void densities in the side margin portions greater than the intragranular void density in the inner-layer portion while setting the intragranular void densities in the outer-layer portions greater than the intragranular void density in the inner-layer portion allows for even more substantial reduction of the formation of cracks. Specifically, for example, the incidence rate of cracks can be reduced to about 5% or less in a flexural test in which the bending amount is set to about 2.5 mm.

From the viewpoint of reducing the incidence rate of cracks in a flexural test of the mounting board, for example, it is preferable that the intragranular void densities in the outer-layer portions (N [outer-layer portion]) about 1 void/μm² or more and about 25 voids/μm² or less, more preferably about 8 voids/μm² or more and about 25 voids/μm² or less, and even more preferably about 12 voids/μm² or more and about 25 voids/μm² or less. The outer-layer portions include the first outer-layer portion and the second outer-layer portion. The intragranular void density in the first outer-layer portion and the intragranular void density in the second outer-layer portion may be the same or may alternatively be different. When N [inner-layer middle portion] and N [outer-layer portion] satisfy the relationship specified above (N [inner-layer middle portion]<N [outer-layer portion]), however, it is preferable that both of the inner void density in the first outer layer and the intragranular void density in the second outer-layer portion satisfy this relationship.

According to an example configuration, the zirconium concentration in the ceramic dielectric of the inner-layer portion (Zr [inner-layer portion]) and the zirconium concentrations in the ceramic dielectrics of the side margin portions (Zr [side margin portion]) satisfy Zr [side margin portion]<Zr [inner-layer portion]. As will be described later, adding grain growth accelerator materials, such as Zr, for example, to the inner-layer green sheets and the side-margin green bodies and controlling their amounts during the manufacture of the multilayer ceramic capacitor helps adjust intragranular void densities. In that case, furthermore, the concentrations of the grain growth accelerator materials (such as Zr) in the inner-layer portion would be higher than those in the side margin portions in the finally obtained multilayer ceramic capacitor.

According to another example configuration, the dielectric particles included in the inner-layer portion and the side margin portions are made of a perovskite oxide, which has a composition represented by ABO₃. Preferably, furthermore, the molar ratios (A/B ratios) in the dielectric particles include in the side margin portions are higher than the molar ratio (A/B ratio) in the dielectric particles include in the inner-layer portion. As will be described later, controlling the molar ratios (A/B ratios) in the primary component powders include in the inner-layer green sheets and the side-margin green bodies during the manufacture of the multilayer ceramic capacitor helps adjust intragranular void densities. In that case, furthermore, the molar ratios in the dielectric particles included in the side margin portions would be higher than the molar ratio in the dielectric particles included in the inner-layer portion in the finally obtained multilayer ceramic capacitor.

The multilayer ceramic capacitor according to the present example embodiment includes dielectric particles including a void therein (voided particles) in the inner-layer portion and the side margin portions, with the intragranular void densities (N [inner-layer middle portion] and N [side margin portion]) controlled to satisfy a predetermined relationship. The multilayer ceramic capacitor, therefore, has the advantage of high reliability owing to reduced insulation resistance (IR) degradation. Although not limited, it is possible to extend the mean time to failure (MTTF) in a highly accelerated life test (HALT), for example, to about 30 hours or more, about 50 hours or more, or about 70 hours or more. The mean time to failure can be determined by the method described in the Examples below or a method equivalent thereto.

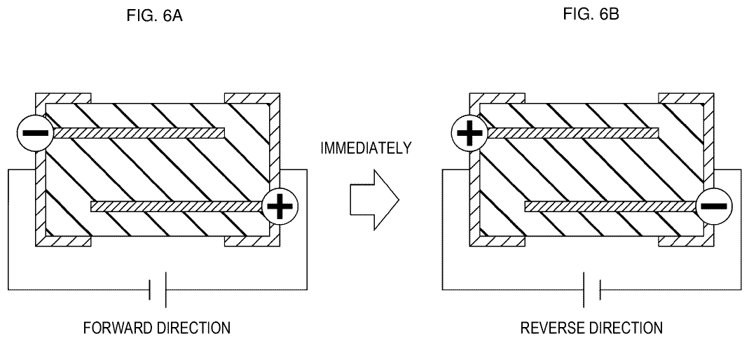

Although not limited, for the multilayer ceramic capacitor according to the present example embodiment, polarity IR can be reduced by controlling the intragranular void density in the inner-layer middle portion (N [inner-layer middle portion]) to fall within a predetermined range. For example, it is possible to reduce the incidence rate of polarity IR to about 3% or less or about 1% or less. The incidence rate of polarity IR can be determined as follows. First, the insulation resistance (IR) is determined with a voltage in the forward direction applied to the multilayer ceramic capacitor. Then the insulation resistance (IR) is determined with a voltage in the reverse direction applied (FIGS. 6A and 6B). After the IR (insulation resistance) values measured with varying directions of voltage application are converted to common logarithms, their difference is determined. The percentage of the number of samples for which the absolute differentiation exceeds about 0.3 (the number of digits of the antilogarithm is greater than about 0.3) is determined as the incidence rate of polarity IR. More specifically, the incidence rate of polarity IR is determined by the method described in the Examples below or a method equivalent to it.

Although not limited, for the multilayer ceramic capacitor according to the present example embodiment, the formation of cracks can be effectively reduced by incorporating voided particles in the outer-layer portions and controlling the intragranular void densities (N [inner-layer middle portion] and N [outer-layer portion]). For example, it is possible to reduce the incidence rate of cracks in a flexural test in which the bending amount of the mounting board set to about 2.5 mm to about 5% or less, about 3% or less, or about 1% or less. The flexural test can be determined by the method described in the Examples below or a method equivalent thereto.

### 2. Method for Manufacturing the Multilayer Ceramic Capacitor

For the multilayer ceramic capacitor according to the present example embodiment, a method for manufacturing is not limited as long as it satisfies the requirements described above. An example of a manufacturing method, however, includes the following steps: a step of synthesizing primary component powders for ceramic dielectrics (synthesis step), a step of mixing secondary component raw materials into the primary component powders to obtain dielectric raw materials (mixing step), a step of adding a binder and a solvent to the dielectric raw materials, mixing them to form slurries, and shaping the resulting slurries into inner-layer green sheets and outer-layer green sheets (shaping step), a step of forming a patterned conductive paste layer on the surface of the inner-layer green sheets using a conductive paste for inner electrodes (printing step), a step of stacking multiple inner-layer green sheets with the conductive paste layer formed thereon, placing the outer-layer green sheets on the top and bottom of the stack, and pressure-bonding the entire structure to produce a multilayer block (stacking step), a step of cutting the resulting multilayer block into multilayer chips (cutting step), a step of attaching side-margin green bodies to the side surfaces of the resulting multilayer chips to produce green body portions (side margin portion formation step), a step of subjecting the resulting green body portions to debinding treatment and firing treatment to convert them into body portions (firing step), and a step of forming outer electrodes on the resulting body portions to produce multilayer ceramic capacitors (outer electrode formation step). The manufacturing conditions, furthermore, are controlled such that in the resulting multilayer ceramic capacitors, each of the ceramic dielectrics constituting the inner-layer portion and the side margin portions (the first side margin portion and the second side margin portion) includes voided particles, satisfies the relationship of N [inner-layer middle portion]<N [side margin portion], and also satisfies the relationship of about 1.00≤D50 [inner-layer W-end portion]/D50 [inner-layer middle portion]≤about 1.40. The details of each step will be described below.

### Synthesis Step

In the synthesis step, primary component powders used to form ceramic dielectrics are synthesized. The primary component powders are powders of dielectrics having a perovskite structure (ABO₃), such as BaTiO₃ compounds, for example. As the primary component powders for ceramic dielectrics, hydrothermally synthesized powders are used. This allows for producing multilayer ceramic capacitors including dielectric particles including a void therein (voided particles).

The synthesis of the hydrothermally synthesized powders is performed by subjecting a raw material including the A-site element of the perovskite structure (A-site raw material) and a raw material including the B-site element (B-site raw material) to a hydrothermal reaction under high-temperature and high-pressure conditions. Specifically, placing the raw materials into a tightly sealed vessel, such as an autoclave, for example, together with water and heating them causes a hydrothermal reaction. The A-site raw material is a hydroxide, such as barium hydroxide (Ba(OH)₂), for example. The B-site raw material is an oxide, such as titanium oxide (TiO₂) or metatitanic acid (TiO(OH)₂), or its hydrate, for example. The heating temperature can be, for example, about 150° C. or above and about 250° C. or below, although not limited. By drying the product obtained through the hydrothermal reaction, a dielectric powder can be obtained. To increase the crystallinity of the dielectric powder, furthermore, the product may be subjected to heat treatment. The heat treatment can be performed at a temperature of, for example, about 800° C. or above and about 1000° C. or below.

### Mixing Step

In the mixing step, secondary component (e.g., Ni, RE, Mg, Mn, Si, Al, and V) raw materials are mixed into the primary component powders to provide dielectric raw materials. The secondary component raw materials can be known ceramic raw materials, such as, for example, oxides, carbonates, hydroxides, nitrates, organic acid salts, alkoxides, and/or chelate compounds. Besides the secondary component raw materials, furthermore, a composition-controlling agent for the primary component powder may be added. For example, adding a Ba raw material, such as barium carbonate (BaCO₃), when the primary component powders are barium titanate (BaTiO₃) powders helps control the composition (A/B ratio) of the primary component of the ceramic dielectrics include in the multilayer ceramic capacitors. The mixing method is not particularly limited. An example is a method of weighing out the primary component powder and the secondary component raw materials and mixing and grinding them by a wet process, together with a grinding medium and water, using a ball mill. When the mixing is performed by a wet process, the mixture can be dried.

### Shaping Step

In the shaping step, a binder and a solvent are added to the dielectric raw materials, the materials are mixed to form slurries, and the resulting slurries are shaped into inner-layer green sheets and outer-layer green sheets. The binder can be a known organic binder, such as a polyvinyl butyral binder, for example. The solvent, furthermore, can be a known organic solvent, such as toluene or ethanol, for example. Additives, such as a plasticizer, for example, may optionally be added. The shaping can be performed by a known method, such as RIP, for example. The thickness of the shaped sheets is, for example, about 4 μm or less.

### Printing Step

In the printing step, a patterned conductive paste layer is formed on the surface of the inner-layer green sheets using a conductive paste. The conductive paste layer forms an inner electrode layer after firing. The conductive metal included in the conductive paste can be a conductive material such as, for example, nickel (Ni), copper (Cu), silver (Ag), palladium (Pd), or an alloy including such metals. In addition, a ceramic component that acts as a common material may be added to the conductive paste. The ceramic component can be the primary component powder for the dielectric layers. The method for forming the conductive paste layer is not particularly limited. Examples include methods such as screen printing and gravure printing.

### Stacking Step

In the stacking step, multiple inner-layer green sheets with the conductive paste layer formed thereon are stacked, and the outer-layer green sheets are placed on the top and bottom of the stack. Then the entire structure is pressure-bonded to produce a multilayer block. The inner-layer green sheets form the ceramic dielectric of the inner-layer portion of the multilayer ceramic capacitors (the inner-layer ceramic) through the firing step. The outer-layer green sheets form the ceramic dielectrics of the outer-layer portions (the outer-layer ceramics). The number of green sheets stacked can be adjusted such that the required capacitance is achieved.

### Cutting Step

In the cutting step, the resulting multilayer block is cut into multilayer chips. The cutting can be performed such that chips of a predetermined size are obtained, and that the conductive paste layers are exposed on the end surfaces and side surfaces of the multilayer chips.

### Side Margin Portion Formation Step

In the side margin portion formation step, side-margin green bodies are attached to the side surfaces of the multilayer chips to produce green body portions. By the side-margin green bodies, the conductive paste layers exposed on the side surfaces of the multilayer chips are covered. The side-margin green bodies, furthermore, form the side margin portions of the multilayer ceramic capacitors after firing. The raw materials for the side-margin green bodies (raw material powders for the side margin portions) can be, for example, the primary component powder and secondary component raw materials used to produce the inner-layer green sheets.

The production and attachment of the side-margin green bodies can be performed by known methods. An example is a method of producing green sheets from the dielectric raw material intended as a raw material for the side margin portions and attaching these green sheets to the side surfaces of the multilayer chips. In this process, an adhesive adjunct, such as an organic solvent, for example, may be applied to the side surfaces of the multilayer chips beforehand to ensure the bonding of the green sheets. An alternative example is the method of producing a paste from the dielectric raw material, applying this paste to the side surfaces of the multilayer chips, and drying the applied paste. The side-margin green bodies may be single-layer or may alternatively be multilayer bodies, consisting of multiple layers. Side-margin green bodies that are multilayer bodies can be obtained by a method of stacking multiple green sheets on the side surfaces of the multilayer chips or a method of repeating the application and drying of a paste, for example.

The resulting green body portions may optionally be subjected to barrel polishing treatment. This treatment allows for rounding the corner portions and/or edge portions of the green body portions.

### Firing Step

In the firing step, the green body portions are subjected to debinding treatment and firing treatment to convert them into body portions. Through the firing treatment, the conductive paste layers and the inner-layer green sheets are co-sintered, forming the inner electrode layers and ceramic dielectric constituting the inner-layer portion. The outer-layer green sheets sinter to form the ceramic dielectrics constituting the outer-layer portions. The side-margin green bodies sinter to form the ceramic dielectrics constituting the side margin portions.

The conditions for the debinding treatment can be determined according to the types of organic binders include in the green sheets and the conductive paste layers. The firing treatment, furthermore, can be performed at a temperature at which the multilayer chips are densified sufficiently. For example, it can be performed under conditions under which the chips are held at a temperature of about 1200° C. or above and about 1400° C. or below for about 0 minutes or more and about 10 minutes or less. The firing, moreover, is performed in an atmosphere in which the primary component compound, such as BaTio₃, for example, is not reduced and in which the oxidation of the conductive material is limited. For example, it can be performed in a N₂—H₂-H₂O gas stream with a partial pressure of oxygen of about 1.7×10⁻⁷ to about 5.8×10⁻¹⁰ MPa. In addition, annealing treatment may be applied after the firing.

### Outer Electrode Formation Step

In the outer electrode formation step, outer electrodes are formed on the body portions to complete multilayer ceramic capacitors. The formation of the outer electrodes can be performed by a known method. For example, a conductive paste including a conductive component, such as Cu or Ni, for example, as its primary component is applied to the end surfaces of the body portions, on which extended inner electrodes are exposed, and baked to form a base layer. The base layer may be formed by, for example, a method of applying a conductive paste to both end surfaces of the green body portions, which have yet to be fired, and then subjecting the green body portions to firing treatment. After the formation of the base layer, a plating coating, for example, of Ni or Sn, can be formed on the surface of the base layer by applying electrolytic plating. Through this, multilayer ceramic capacitors are produced.

### Control of Intragranular Void Densities

In an example of a manufacturing method according to the present example embodiment, the manufacturing conditions are controlled such that in the resulting multilayer ceramic capacitors, each of the ceramic dielectrics of the inner-layer portion and the side margin portions (the first side margin portion and the second side margin portion) includes voided particles. Specifically, hydrothermally synthesized powders are used at least as the primary component powders include in the inner-layer green sheets and the side-margin green bodies. As each primary component powder, a hydrothermally synthesized powder alone may be used, or, alternatively, a hydrothermally synthesized powder and a powder synthesized by a method other than the hydrothermal method may be used in combination. Although not limited, examples of methods other than the hydrothermal method include the solid-phase method, the sol-gel method, the alkoxide hydrolysis method, the solvothermal method, or the oxalate method. In addition, particle diameters may be adjusted by crushing the synthesized primary component powders.

The primary component powder included in the outer-layer green sheets, on the other hand, may be a hydrothermally synthesized powder or may alternatively be a dielectric powder synthesized by a method other than the hydrothermal method. The use of a hydrothermally synthesized powder, however, is preferable. This allows for the introduction of voided particles into the ceramic dielectrics of the outer-layer portions.

Moreover, in the manufacturing method according to the present example embodiment, the manufacturing conditions are controlled such that in the resulting multilayer ceramic capacitor, the intragranular void density in the inner-layer middle portion (N [inner-layer middle portion]) and the intragranular void densities in the side margin portions (the first side margin portion and the second side margin portion) (N [side margin portion]) satisfy the relationship of the formula: N [inner-layer middle portion]<N [side margin portion], and that the D50 diameter of dielectric particles in the inner-layer W-end portion (D50 [inner-layer W-end portion]) and the D50 diameter of dielectric particles in the inner-layer middle portion (D50 [inner-layer middle portion]) satisfy the relationship of the formula: about 1.00≤D50 [inner-layer W-end portion]/D50 [inner-layer middle portion]≤about 1.40.

The method for controlling the intragranular void densities and the D50 diameters is not limited. An example is a method of adding, for example, grain growth accelerator materials or grain growth inhibitor materials to the primary component powders and adjusting their amounts. Examples of grain growth accelerator materials include zirconium (Zr), silicon (Si), vanadium (V), and/or aluminum (Al). The dielectric particles grow during the firing step. In this process, intragranular voids become smaller as grain growth proceeds and, in some cases, disappear. Adding grain growth accelerator materials to the inner-layer green sheets, the outer-layer green sheets, or the side-margin green bodies and adjusting their amounts, therefore, helps control the intragranular void density(ies) in the corresponding portion(s).

An alternative example is a method of adjusting the composition of the primary component powders. The primary component powders are perovskite oxides, which have a composition represented by the formula: ABO₃, typified by BaTiO₃, for example. For perovskite oxides, grain growth is accelerated with decreasing molar ratio of the A-site element (e.g., Ba) to the B-site element (e.g., Ti) (A/B ratio). Adjusting the molar ratio (A/B ratio) in the primary component powder include in the inner-layer green sheets, the outer-layer green sheets, or the side-margin green bodies, therefore, helps control the intragranular void density(ies) in the corresponding portion(s).

In addition, a method of adjusting the particle diameter of raw material particles, such as the primary component powders, is also possible. The smaller the raw material particles, the faster grain growth proceeds. Adjusting the particle diameter of the primary component powder for the inner-layer green sheets, the outer-layer green sheets, or the side-margin green bodies, therefore, helps control the intragranular void density(ies) in the corresponding portion(s).

Another possible example is a method of adding a dielectric powder synthesized by a method other than the hydrothermal method, such as the solid-phase method, to the primary component powders, for example. As stated earlier, whereas hydrothermally synthesized powders include intragranular voids, dielectric powders synthesized by methods other than the hydrothermal method include no intragranular voids. Using a hydrothermally synthesized powder and a dielectric powder synthesized by a method other than the hydrothermal method in combination and adjusting their percentages, therefore, helps control the intragranular void density(ies) in the corresponding portion(s).

As long as the intragranular void densities and the D50 diameters in the inner-layer portion, the outer-layer portions, and the side margin portions can be controlled to satisfy the predetermined relationships in the finally obtained multilayer ceramic capacitors, the method is not limited.

### EXAMPLES

Example embodiments of the present invention will be more specifically described using the following examples and comparative example. The present invention, however, is not limited to the following examples.

### 1 Production of Multilayer Ceramic Capacitors

### Example 1

In Example 1, inner-layer green sheets, outer-layer green sheets, and side-margin green bodies were produced using a barium titanate (BaTiO₃) powder synthesized by the hydrothermal method as the primary component powder, and multilayer ceramic capacitors were produced using them. The specific production procedure is presented below.

### Synthesis of the Primary Component Powder

A barium titanate (BaTiO₃) powder was synthesized by the hydrothermal method. First, a titanium oxide (TiO₂) powder and a barium hydroxide (Ba(OH)₂) powder were weighed out, and purified water was added to them to produce a slurry. Then the produced slurry was placed into a tightly sealed vessel, and the temperature of the slurry was raised to about 200° C. to about 250° C. with stirring. Then the slurry was maintained at about 200° C. to about 250° C. for about 4 to about 24 hours to allow a liquid-phase reaction to proceed. After that, the internal pressure of the tightly sealed vessel was returned to atmospheric pressure, the heating of the tightly sealed vessel was terminated, and the slurry was allowed to stand. After cooling, the slurry was removed from the tightly sealed vessel and placed into a drying oven, followed by the evaporation of water. In such a manner, a hydrothermally synthesized BaTiO₃ powder with an average particle diameter of about 130 nm was obtained.

Production of Inner-Layer Green Sheets Separately from the hydrothermally synthesized BaTiO₃ powder, dysprosium oxide (Dy₂O₃), magnesium carbonate (MgCO₃), manganese carbonate (MnCO₃), silicon oxide (SiO₂), and vanadium oxide (V₂O₅) were prepared as secondary component raw materials. In addition to these, barium carbonate (BaCO₃) and zirconium oxide (ZrO₂) were prepared. These secondary component raw materials, BaCO₃, and ZrO₂ were added to the BaTiO₃ powder (average particle diameter, 130 nm), and the resulting mixture was wet-ground for about 24 hours in water using a ZrO₂ ball mill (compounding) and then dried. The product was used as the dielectric raw material for the inner layers. The amount of BaCO₃ added was adjusted such that the Ba/Ti ratio in the ceramic dielectric constituting the inner-layer portion of the finally obtained multilayer ceramic capacitors (the inner-layer ceramic) was about 1.0027. The Ba/Ti ratio is a ratio on a molar amount basis. The amount of ZrO₂ added, furthermore, was set to about 0.55% by mass in relation to the BaTiO₃ powder. Subsequently, a polyvinyl butyral binder and ethanol as an organic solvent were added to the resulting dielectric raw material, and wet mixing was performed for a predetermined period of time using a ball mill to produce a slurry. By shaping this slurry into sheets, inner-layer green sheets were produced.

Production of Outer-Layer Green Sheets Separately from the hydrothermally synthesized BaTiO₃ powder, dysprosium oxide (Dy₂O₃), magnesium carbonate (MgCO₃), manganese carbonate (MnCO₃), silicon oxide (SiO₂), and vanadium oxide (V₂O₅) were prepared as secondary component raw materials. In addition to these, barium carbonate (BaCO₃) and zirconium oxide (ZrO₂) were prepared. These secondary component raw materials, BaCO₃, and ZrO₂ were added to the BaTiO₃ powder (average particle diameter, about 130 nm), and the resulting mixture was wet-ground for about 24 hours in water using a ZrO₂ ball mill (compounding) and then dried. The product was used as the dielectric raw material for the outer layers. The amount of BaCO₃ added was adjusted such that the Ba/Ti ratio in the ceramic dielectrics of the outer-layer portions of the finally obtained multilayer ceramic capacitors (the outer-layer ceramics) was about 1.0027. The amount of ZrO₂ added, furthermore, was set to about 0.55% by mass in relation to the BaTio₃ powder. Subsequently, a polyvinyl butyral binder and ethanol as an organic solvent were added to the resulting dielectric raw material, and wet mixing was performed for a predetermined period of time using a ball mill to produce a slurry. By shaping this slurry into sheets, outer-layer green sheets were produced.

### Production of Side-Margin Green Bodies

Separately from the hydrothermally synthesized BaTiO₃ powder, dysprosium oxide (Dy₂O₃), magnesium carbonate (MgCO₃), manganese carbonate (MnCO₃), silicon oxide (SiO₂), and vanadium oxide (V₂O₅) were prepared as secondary component raw materials. In addition to these, barium carbonate (BaCO₃) was prepared. These secondary component raw materials and BaCO₃ were added to the BaTiO₃ powder (average particle diameter, about 130 nm), and the resulting mixture was wet-ground for about 12 hours in water using a ZrO₂ ball mill (compounding) and then dried. The product was used as the dielectric raw material for the side-margin green bodies. The amount of BaCO₃ added was adjusted such that the Ba/Ti ratio in the ceramic dielectrics of the side margin portions of the finally obtained multilayer ceramic capacitors (the side-margin ceramics) was about 1.0040. Subsequently, a polyvinyl butyral binder and ethanol as an organic solvent were added to the resulting dielectric raw material, and wet mixing was performed for a predetermined period of time using a ball mill to produce a slurry. By shaping this slurry into sheets, side-margin green bodies were produced.

### Production of Multilayer Bodies

To the surface of the resulting inner-layer green sheets, a Ni-based conductive paste was applied by screen printing to form patterns of conductive paste layers to serve as the inner electrode layers. After that, multiple inner-layer green sheets with the conductive paste layer formed thereon were stacked, and the outer-layer green sheets, without a conductive paste layer formed thereon, were placed on the top and bottom of the stack. By pressure-bonding the entire structure, a multilayer block was produced. Then the resulting multilayer block was cut using a dicing saw into multilayer chips. The stacking was performed such that the extended end portions of the conductive paste layers alternated. The cutting, furthermore, was performed such that the conductive paste layers were exposed on the side surfaces, and that the extended portions of the conductive paste layers were exposed on the end surfaces.

To both side surfaces of the cut multilayer chips, on which the conductive paste layers were exposed, the side-margin green bodies were attached to produce green body portions.

The resulting green body portions were subjected to heat treatment in a N₂ gas stream under the conditions of a maximum temperature of about 270° C., and then subjected to heat treatment in a N₂—H₂O—H₂ gas stream under the conditions of a maximum temperature of about 800° C. After that, the green body portions were fired in a N₂—H₂O—H₂ gas stream. The firing was performed under the conditions of a maximum temperature of about 1250° C. to about 1320° C., a temperature elevation rate of about 20° C./second to about 60° C./second, a retention time of about 60 minutes, and a partial pressure of oxygen of about 3.2×10⁻⁹ to about 6.4×10⁻¹⁰ MPa. Subsequently, heat treatment was applied in a N₂—H₂O—H₂ gas stream under the conditions of a maximum temperature of about 1050° C.×about 60 minutes. Through this, body portions were obtained.

To the end surfaces of the body portions obtained through firing, to which the inner electrode layers had been extended, a conductive paste including copper (Cu) as its primary component was applied. After that, the applied conductive paste was baked at about 900° C. to form the base layer of the outer electrodes. On the surface layer of the base layer, furthermore, Ni plating and Sn plating were performed in this order by wet plating. In such a manner, multilayer ceramic capacitors were produced.

The produced multilayer ceramic capacitors had a length L dimension of about 1.0 mm, a dimension in the width direction W of about 0.5 mm, and a dimension in the thickness direction T of about 0.5 mm. In the inner-layer portion, furthermore, the thickness of the dielectric layers was about 0.80 μm, the thickness of the inner electrode layers was about 0.47 μm, and the number of dielectric layers was 345.

### Example 2

In Example 2, during the production of the inner-layer green sheets, the amount of BaCO₃ added was adjusted such that the Ba/Ti ratio in the inner-layer ceramic was about 1.0015. The amount of ZrO₂ added, furthermore, was changed from about 0.55% by mass to about 0.3% by mass. Moreover, the amount of ZrO₂ added during the production of the outer-layer green sheets was changed from about 0.55% by mass to about 0.3% by mass. Except for these, multilayer ceramic capacitors were produced in the same or substantially the same manner as in Example 1.

### Example 3

In Example 3, during the production of the side-margin green bodies, the amount of BaCO₃ added was adjusted such that the Ba/Ti ratio in the side-margin ceramics was about 1.0027. Together with BaCO₃, furthermore, ZrO₂ was added, and its amount added (the amount of ZrO₂ added) was set to about 0.3% by mass in relation to the BaTio₃ powder. Moreover, the duration of grinding was changed from about 12 hours to about 24 hours. Except for these, multilayer ceramic capacitors were produced in the same or substantially the same manner as in Example 1.

### Example 4

In Example 4, during the production of the side-margin green bodies, the amount of BaCO₃ added was adjusted such that the Ba/Ti ratio in the side-margin ceramics was about 1.0027. Together with BaCO₃, furthermore, ZrO₂ was added, and its amount added (the amount of ZrO₂ added) was set to about 0.3% by mass in relation to the BaTiO₃ powder. Except for these, multilayer ceramic capacitors were produced in the same or substantially the same manner as in Example 1.

### Example 5

In Example 5, the amount of ZrO₂ added was changed from about 0.55% by mass to about 0.4% by mass during the production of the inner-layer ceramic green sheets. Except for this, multilayer ceramic capacitors were produced in the same or substantially the same manner as in Example 1.

### Example 6

In Example 6, the amount of ZrO₂ added during the production of the inner-layer ceramic green sheets was changed from about 0.55% by mass to about 0.3% by mass. Except for this, multilayer ceramic capacitors were produced in the same or substantially the same manner as in Example 1.

### Example 7

In Example 7, the amount of ZrO₂ added during the production of the outer-layer ceramic green sheets was changed from about 0.55% by mass to about 0.3% by mass. Except for this, multilayer ceramic capacitors were produced in the same or substantially the same manner as in Example 1.

### Example 8

In Example 8, the amount of ZrO₂ added during the production of the outer-layer ceramic green sheets was changed from about 0.55% by mass to about 0.4% by mass. Except for this, multilayer ceramic capacitors were produced in the same or substantially the same manner as in Example 1.

### Example 9

In Example 9, a hydrothermally synthesized BaTiO₃ powder (average particle diameter, about 160 nm) was used instead of the hydrothermally synthesized BaTiO₃ powder (average particle diameter, about 130 nm) during the production of the outer-layer green sheets. Except for this, multilayer ceramic capacitors were produced in the same or substantially the same manner as in Example 1. The hydrothermally synthesized BaTiO₃ powder (average particle diameter, about 160 nm) was synthesized through the same or substantially the same procedure as the hydrothermally synthesized BaTiO₃ powder (average particle diameter, about 130 nm), except that the slurry temperature during the hydrothermal was increased.

### Example 10

In Example 10, during the production of the outer-layer green sheets, the amount of BaCO₃ added was adjusted such that the Ba/Ti ratio in the outer-layer ceramics was about 1.0040. ZrO₂, furthermore, was not added. Moreover, the duration of grinding was changed from about 24 hours to about 12 hours. Except for these, multilayer ceramic capacitors were produced in the same or substantially the same manner as in Example 1.

### Example 11

In Example 11, during the production of the outer-layer green sheets, the amount of BaCO₃ added was adjusted such that the Ba/Ti ratio in the outer-layer ceramics was about 1.0040, and ZrO₂ was not added. Moreover, the duration of grinding was changed from about 24 hours to about 12 hours.

In addition, during the production of the side-margin green bodies, a hydrothermally synthesized BaTiO₃ powder (average particle diameter, about 100 nm) was used instead of the hydrothermally synthesized BaTiO₃ powder (average particle diameter, about 130 nm). The amount of BaCO₃ added, furthermore, was adjusted such that the Ba/Ti ratio in the side-margin ceramics was about 1.0045. Except for these, multilayer ceramic capacitors were produced in the same or substantially the same manner as in Example 1. The hydrothermally synthesized BaTiO₃ powder (average particle diameter, about 100 nm) was synthesized through the same or substantially the same procedure as the hydrothermally synthesized BaTiO₃ powder (average particle diameter, about 130 nm), except that the slurry temperature during the hydrothermal was lowered.

### Example 12

In Example 12, during the production of the outer-layer green sheets, a hydrothermally synthesized BaTiO₃ powder (average particle diameter, about 100 nm) was used instead of the hydrothermally synthesized BaTiO₃ powder (average particle diameter, about 130 nm). The amount of BaCO₃ added, furthermore, was adjusted such that the Ba/Ti ratio in the outer-layer ceramics was about 1.0045, and ZrO₂ was not added. Moreover, the duration of grinding was changed from about 24 hours to about 12 hours. Except for these, multilayer ceramic capacitors were produced in the same or substantially the same manner as in Example 1.

### Example 13

In Example 13, the amount of ZrO₂ added during the production of the inner-layer ceramic green sheets was changed from about 0.55% by mass to about 0.2% by mass. Except for this, multilayer ceramic capacitors were produced in the same or substantially the same manner as in Example 1.

### Comparative Example 1

In Comparative Example 1, during the production of the side-margin green bodies, a hydrothermally synthesized BaTiO₃ powder (average particle diameter, about 150 nm) was used instead of the hydrothermally synthesized BaTiO₃ powder (average particle diameter, about 130 nm). The amount of BaCO₃ added, furthermore, was adjusted such that the Ba/Ti ratio in the side-margin ceramics was about 1.0027. Moreover, together with BaCO₃, ZrO₂ was added, and its amount added (the amount of ZrO₂ added) was set to about 0.55% by mass in relation to the BaTiO₃ powder. In addition to these, the duration of grinding was changed from about 12 hours to about 24 hours. Except for these, multilayer ceramic capacitors were produced in the same or substantially the same manner as in Example 1. The hydrothermally synthesized BaTiO₃ powder (average particle diameter, about 150 nm) was synthesized through the same or substantially the same procedure as the hydrothermally synthesized BaTiO₃ powder (average particle diameter, about 130 nm), except that the slurry temperature during the hydrothermal was increased.

The manufacturing conditions for the multilayer ceramic capacitors in Examples 1 to 13 and Comparative Example 1 are summarized in Table 1 below.

TABLE 1
Manufacturing Conditions for the Multilayer Ceramic Capacitors

| | Average particle | | | | | | | | | | | |
|---|---|---|---|---|---|---|---|---|---|---|---|---|
| | diameter (μm) of | | | | | | | | | | | |
| | hydrothermally | | | | | | Amount of ZrO₂ added | | | Duration of wet grinding | | |
| | synthesized BaTiO₃ | | | Ba/Ti ratio | | | (% by mass) | | | in water (hours) | | |
| | Inner- | Outer- | | Inner- | Outer- | | Inner- | Outer- | | Inner- | Outer- | |
| | layer | layer | Side | layer | layer | Side | layer | layer | Side | layer | layer | Side |
| | portion | portions | portions | portion | portions | portions | portion | portions | portions | portion | portions | portions |
| Example 1 | 130 | 130 | 130 | 1.0027 | 1.0027 | 1.0040 | 0.55 | 0.55 | 0 | 24 | 24 | 12 |
| Example 2 | 130 | 130 | 130 | 1.0015 | 1.0027 | 1.0040 | 0.3 | 0.3 | 0 | 24 | 24 | 12 |
| Example 3 | 130 | 130 | 130 | 1.0027 | 1.0027 | 1.0027 | 0.55 | 0.55 | 0.3 | 24 | 24 | 24 |
| Example 4 | 130 | 130 | 130 | 1.0027 | 1.0027 | 1.0027 | 0.55 | 0.55 | 0.3 | 24 | 24 | 12 |
| Example 5 | 130 | 130 | 130 | 1.0027 | 1.0027 | 1.0040 | 0.4 | 0.55 | 0 | 24 | 24 | 12 |
| Example 6 | 130 | 130 | 130 | 1.0027 | 1.0027 | 1.0040 | 0.3 | 0.55 | 0 | 24 | 24 | 12 |
| Example 7 | 130 | 130 | 130 | 1.0027 | 1.0027 | 1.0040 | 0.55 | 0.3 | 0 | 24 | 24 | 12 |
| Example 8 | 130 | 130 | 130 | 1.0027 | 1.0027 | 1.0040 | 0.55 | 0.4 | 0 | 24 | 24 | 12 |
| Example 9 | 130 | 160 | 130 | 1.0027 | 1.0027 | 1.0040 | 0.55 | 0.55 | 0 | 24 | 24 | 12 |
| Example 10 | 130 | 130 | 130 | 1.0027 | 1.0040 | 1.0040 | 0.55 | 0 | 0 | 24 | 12 | 12 |
| Example 11 | 130 | 130 | 100 | 1.0027 | 1.0040 | 1.0045 | 0.55 | 0 | 0 | 24 | 12 | 12 |
| Example 12 | 130 | 100 | 130 | 1.0027 | 1.0045 | 1.0040 | 0.55 | 0 | 0 | 24 | 12 | 12 |
| Example 13 | 130 | 130 | 130 | 1.0027 | 1.0027 | 1.0040 | 0.2 | 0.55 | 0 | 24 | 24 | 12 |
| Comparative | 130 | 130 | 150 | 1.0027 | 1.0027 | 1.0027 | 0.55 | 0.55 | 0.55 | 24 | 24 | 24 |
| Example 1 | | | | | | | | | | | | |

Note 1)
The “side portions” refers to “side margin portions.”

### 2 Evaluations

For the multilayer ceramic capacitors produced in Examples 1 to 13 and Comparative Example 1, the evaluation of characteristics was performed as follows.

### TEM Observation

Using a transmission electron microscope (TEM), the proportion of intragranular voids was examined as follows for the inner-layer middle portion, the inner-layer W-end portion, the side margin portions, and the outer-layer portions of the multilayer ceramic capacitor. First, a WT plane of the multilayer ceramic capacitor was exposed by polishing the capacitor until the dimension in the length L direction decreased to approximately ½. Then, in the polished body portion, a dielectric layer located at approximately ½ the thickness T dimension was designated, and a region located at approximately ½ the width W dimension was defined as the inner-layer middle portion (FIG. 4A). For the designated dielectric layer, furthermore, a boundary between the inner electrode layers and a side margin portion was defined. With this boundary as the starting point, the portion of the dielectric layer within a distance of about 3 μm toward the inner-layer middle portion was defined as the inner-layer W-end portion (FIGS. 4A and 4B). When the respective end portions of the pair of inner electrode layers were misaligned in the W direction in this process, the end portion in closer proximity to the inner-layer middle portion was chosen as the boundary (FIG. 4B). To include each of the regions designated in such a manner, samples for the inner-layer middle portion and the inner-layer W-end portion were separately cut out. The thickness of each was reduced to about 100 nm or less, and the resulting thin pieces were used as TEM observation samples for examining the proportion of intragranular voids in the inner-layer middle portion and the inner-layer W-end portion. For the side margin portions, a sample was cut out at a position that was approximately ½ the thickness T dimension and approximately ½ the width of a side margin in the polished body portion, its thickness was reduced to about 100 nm or less, and the resulting thin piece was used as a TEM sample for examining the proportion of intragranular voids. As for the outer-layer portions, a sample was cut out at a position that was approximately ½ the width W dimension and approximately ½ the thickness of an outer layer in the polished body portion, its thickness was reduced to about 100 nm or less, and the resulting thin piece was used as a TEM sample for examining the proportion of intragranular voids.

Then, for each of the inner-layer middle portion, the inner-layer W-end portion, the outer-layer portions, and the side margin portions, TEM observation was performed. Within the TEM observation sample prepared, the number of voids present in dielectric particles was counted, and the number of voids per unit area (1 μm²) was calculated by dividing the obtained number by the area of the ceramic portion (using about 10 μm² or more as a guideline). For each of the inner-layer middle portion, the inner-layer W-end portion, the outer-layer portions, and the side margin portions, the same operation was performed at three points (n=3), and the average number of intragranular voids per unit area was determined as the intragranular void density.

### SEM Observation

Using a scanning electron microscope (SEM), a WT plane of the multilayer ceramic capacitor was observed to examine the thickness of the dielectric layers. Specifically, a cross-section (WT plane) of the multilayer ceramic capacitor was exposed by polishing the capacitor to the approximate middle in the L direction. Then, on the exposed cross-section, a midline in the W direction was drawn, along with two lines on each side at regular intervals from this midline in the W direction. The thickness of a dielectric layer in the inner-layer portion located in the vicinity of the middle in the thickness direction was measured on these five lines in total, and the average was used as the thickness of the dielectric layers.

In addition, an SEM image of dielectric particles in dielectric layers in a WT cross-section in the vicinity of the middle in the L direction was captured under the conditions of a magnification of about 25000×, an acceleration voltage of about 15 kV, and a field of view of about 4 μm×about 5 μm. In this process, the image was captured to include the portion of the dielectric layer selected as the inner-layer middle portion, which was in the vicinity of the middle in the W direction and the T direction, and to include the inner-layer W-end portion of the same dielectric layer. Then, using image processing software, the edges of all dielectric particles (corresponding to grain boundaries) included in a region defined by a length of about 3 μm in the W direction and the thickness of the dielectric layer were recognized. The cross-sectional area of each recognized particle, furthermore, was calculated, and an imaginary circle with an area equal or substantially equal to it was considered. The diameter of this imaginary circle (equivalent circular diameter) defined as the diameter of the particle. Excluding dielectric particles a portion of which was outside the designated domain, the equivalent circular diameters of all dielectric particles included within the captured area were measured. Then the D50 diameter in the inner-layer middle portion (D50 [inner-layer middle portion]) and the D50 diameter in the inner-layer W-end portion (D50 [inner-layer W-end portion]) were determined. The D50 diameters are cumulative about 50% diameters based on the cross-sectional area of the dielectric particles. That is, the total cross-sectional area is determined by summing up the cross-sectional areas of all dielectric particles measured, and the cross-sectional areas are normalized to make the total about 100%. Then the cumulative cross-sectional area is determined by sequentially adding the cross-sectional areas, starting with the particle having the smallest cross-sectional area. The equivalent circular diameter of the particle at which the cumulative cross-sectional area reaches about 50% of the total cross-sectional area is determined as the D50 diameter.

### HALT

Using the multilayer ceramic capacitors as samples, a highly accelerated life test (HALT) was performed to determine their mean time to failure (MTTF). In the test, the following loads were applied to the samples: temperature, about 150° C.; voltage, about 50 V. The time at which the insulation resistance (IR) decreased to about 200 kΩ or less, furthermore, was defined as the time to failure. For 72 samples produced under the same or substantially the same conditions, the time to failure was measured.

Subsequently, the obtained data were plotted on Weibull probability paper, and the Weibull distribution was determined. In the resulting Weibull distribution, the relationship between the time to failure and the cumulative failure rate was modeled using linear regression, and the slope was determined as the shape parameter m. The time to failure at which the cumulative failure rate reached about 63.2%, furthermore, was read. Using this time to failure and the shape parameter m, corresponding to the slope of the regression line, the mean time to failure (MTTF) was determined.

### Polarity IR

For 100 samples, a voltage of about 25 V was applied for about 60 seconds at room temperature. The current flowing through the sample at this point in time was measured, and the forward IR was calculated based on Ohm's law. Immediately after that, the method of voltage application was reversed, and a voltage of about 25 V was applied to the sample for about 60 seconds at room temperature. The current flowing through the sample at this point in time was measured, and the reverse IR was calculated based on Ohm's law. The common logarithms of the forward IR and the reverse IR were calculated, and then the absolute difference between them (IR difference) was determined. The number of samples with an absolute IR difference exceeding about 0.3 was counted, and the percentage to the number of measured samples was calculated as the incidence rate (%) of polarity IR.

### Flexural Test

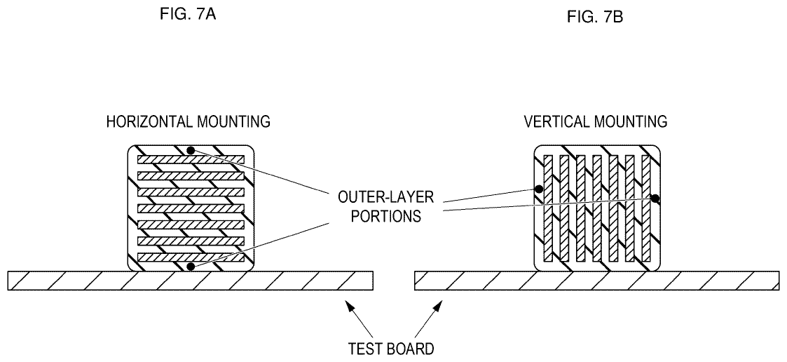

A multilayer ceramic capacitor was solder-mounted on a glass epoxy board (FR-4, about 1.6-mm thick) such that its outer-layer portions were perpendicular or substantially perpendicular to the surface of the board (vertical mounting) (FIG. 7B). A load was applied to the middle portion of the ceramic body of the multilayer ceramic capacitor at a speed of about 1.0 mm/second from above, and the capacitor was held under the load for about 5±1 seconds, with the times at which the bending amount reached about 2.0 mm and about 2.5 mm as starting points. After that, the LW surface of the held multilayer ceramic capacitor was polished in the T direction, perpendicular or substantially perpendicular to this surface, until it was reduced to about ½ of the dimension in the T direction. The polished surface was observed for the formation of cracks, and the obtained results were recorded. The number of samples in this flexural test with vertical mounting was ten.

Subsequently, another multilayer ceramic capacitor was prepared, and it was solder-mounted on a glass epoxy board such that its outer-layer portions were parallel or substantially parallel to the surface of the board (horizontal mounting) (FIG. 7A). A load was applied to the middle portion of the ceramic body of the multilayer ceramic capacitor at a speed of about 1.0 mm/second from above, and the capacitor was held under the load for about 5±1 seconds, with the times at which the bending amount reached about 2.0 mm and about 2.5 mm as starting points. After that, the LT surface of the held multilayer ceramic capacitor was polished in the W direction, perpendicular or substantially perpendicular to this surface, until it was reduced to about ½ of the W dimension. The polished surface was observed for the formation of cracks, and the obtained results were recorded. The number of samples in this flexural test with horizontal mounting was ten.

Then, from the results of the vertical mounting test and the horizontal mounting test, the incidence rate of cracks was calculated according to formula (1) below. In formula (1) below, n [vertical] represents the number of samples in which a crack formed in the vertical mounting test, and n [horizontal] represents the number of samples in which a crack formed in the horizontal mounting test. N [total], furthermore, is the total number of samples subjected to the test (the vertical mounting test and the horizontal mounting test) (20).

$$Incidence rate ( \% ) of cracks = \frac{n [ vertical ] + n [ horizontal ]}{N [ total ]} \times 100 \qquad ( 1 )$$

### 3 Evaluation Results

The evaluation results obtained for Examples 1 to 13 and Comparative Example 1 are summarized in Table 2.

In Examples 1 to 13, the intragranular void density in the side margin portions (N [side margin portion]) was greater than the intragranular void density in the inner-layer middle portion (N [inner-layer middle portion]). The ratio between the average particle diameter of dielectric particles in the inner-layer middle portion and the D50 diameter of dielectric particles in the inner-layer W-end portion (D50 [inner-layer W-end portion]/D50 [inner-layer middle portion]), furthermore, satisfied the relationship of it being about 1.00 or greater and about 1.40 or less. As a result, the mean time to failure (MTTF) was relatively long, exceeding about 30 hours.

In Examples 1 to 12, polarity IR was reduced in addition to the above advantages. Specifically, the intragranular void density in the inner-layer middle portion was about 10 voids/μm² or less, and thus the incidence rate of polarity IR was as low as about 3% or less.

In Examples 7, 8, and 10 to 12, the formation of cracks was reduced in addition to the above advantages. Specifically, the intragranular void density in the outer-layer portions (N [outer-layer portion]) was greater than the intragranular void density in the inner-layer middle portion (N [outer-layer portion]). As a result, the incidence rate of cracks in the flexural test with a bending amount of about 2.5 mm was as low as about 5% or less.

In Comparative Example 1, in contrast, the intragranular void density in the side margin portions (N [side margin portion]) was smaller than the intragranular void density in the inner-layer middle portion (N [inner-layer middle portion]). As a result, the MTTF was relatively short, about 27 hours.

TABLE 2
Evaluation Results for the Multilayer Ceramic Capacitors

| | Intragranular void | | | | | | | | | |
|---|---|---|---|---|---|---|---|---|---|---|
| | density (voids/μm²) | | | | | | | | | |
| | (average of fields of | | | D50 diameter of | | | | | | |
| | view, n = 3, in a 2-um | | | dielectric particles | | | | | | |
| | square area) | | | (nm) | | | | Incidence | | |
| | Inner- | | | Inner- | Inner- | | | rate (%) | Incidence rate | |
| | layer | Outer- | | layer | layer | W- | | of | (%) of cracks | |
| | middle | layer | Side | middle | W-end | end/ | MTTF | polarity | Bending | Bending |
| | portion | portions | portions | portion | portion | middle | (hr) | IR | 2 mm | 2.5 mm |
| Example 1 | 3 | 3 | 15 | 190 | 193 | 1.02 | 61 | 0 | 0 | 10 |
| Example 2 | 2 | 2 | 15 | 190 | 190 | 1.00 | 72 | 0 | 0 | 15 |
| Example 3 | 3 | 3 | 5 | 193 | 270 | 1.40 | 32 | 0 | 0 | 15 |
| Example 4 | 2 | 2 | 10 | 189 | 221 | 1.17 | 48 | 0 | 0 | 15 |
| Example 5 | 7 | 3 | 15 | 177 | 184 | 1.04 | 60 | 1 | 0 | 10 |
| Example 6 | 10 | 3 | 15 | 172 | 183 | 1.06 | 62 | 3 | 0 | 15 |
| Example 7 | 3 | 12 | 16 | 191 | 194 | 1.02 | 65 | 0 | 0 | 0 |
| Example 8 | 2 | 8 | 15 | 193 | 199 | 1.03 | 60 | 0 | 0 | 5 |
| Example 9 | 3 | 1 | 16 | 193 | 195 | 1.01 | 65 | 0 | 0 | 20 |
| Example 10 | 4 | 15 | 15 | 185 | 190 | 1.03 | 61 | 0 | 0 | 0 |
| Example 11 | 3 | 16 | 26 | 190 | 195 | 1.03 | 68 | 0 | 0 | 0 |
| Example 12 | 3 | 25 | 17 | 190 | 197 | 1.04 | 60 | 0 | 0 | 0 |
| Example 13 | 12 | 3 | 16 | 170 | 192 | 1.13 | 55 | 5 | 0 | 15 |
| Comparative | 4 | 4 | 2 | 187 | 265 | 1.42 | 27 | 0 | 0 | 40 |
| Example 1 | | | | | | | | | | |

Note 1)
The “side portions” refers to “side margin portions.”
Note 2)
The “W-end/middle” refers to “inner-layer W-end portion/inner-layer middle portion.”

From these results, it is understood that according to example embodiments of the present invention, multilayer ceramic capacitors each with reduced insulation resistance degradation and high reliability are provided.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
an inner-layer portion including at least one first inner electrode layer and at least one second inner electrode layer alternately stacked with at least one dielectric layer including a ceramic dielectric interposed therebetween, a first primary surface facing a stacking direction, a second primary surface opposite to the first primary surface, a first side surface facing a width direction orthogonal or substantially orthogonal to the first primary surface and the second primary surface and to which the first inner electrode layer and the second inner electrode layer are extended, a second side surface opposite to the first side surface and to which the first inner electrode layer and the second inner electrode layer are extended, a first end surface facing a length direction orthogonal or substantially orthogonal to the first primary surface, the second primary surface, the first side surface, and the second side surface, and to which the first inner electrode layer is extended, and a second end surface opposite to the first end surface and to which the second inner electrode layer is extended;
a first outer-layer portion including a ceramic dielectric and covering the first primary surface in the stacking direction;
a second outer-layer portion including a ceramic dielectric and covering the second primary surface in the stacking direction;
a first side margin portion including a ceramic dielectric and covering the inner-layer portion, the first outer-layer portion, and the second outer-layer portion from one side in the width direction;
a second side margin portion including a ceramic dielectric and covering the inner-layer portion, the first outer-layer portion, and the second outer-layer portion from another side in the width direction; and
a pair of outer electrodes on the first end surface and the second end surface and coupled to each of the first inner electrode layer and the second inner electrode layer; wherein
dielectric particles of each of the ceramic dielectrics of the inner-layer portion, the first side margin portion, and the second side margin portion include dielectric particles including a void therein;
an intragranular void density in a middle portion of the inner-layer portion, or an inner-layer middle portion, defined as N [inner-layer middle portion], and intragranular void densities in the first side margin portion and the second side margin portion, defined as N [side margin portion], satisfy a relationship of N [inner-layer middle portion]<N [side margin portion]; and
a D50 diameter of dielectric particles in an end portion in the width direction of the inner-layer portion, or an inner-layer W-end portion, defined as D50 [inner-layer W-end portion], and a D50 diameter of dielectric particles in a middle portion of the inner-layer portion, or the inner-layer middle portion, defined as D50 [inner-layer middle portion], satisfy a relationship of about 1.00≤D50 [inner-layer W-end portion]/D50 [inner-layer middle portion]≤about 1.40.

2. The multilayer ceramic capacitor according to claim 1, wherein the intragranular void density in the inner-layer middle portion, defined as N [inner-layer middle portion], is about 10 voids/μm² or less.

3. The multilayer ceramic capacitor according to claim 1, wherein
the ceramic dielectrics of the first outer-layer portion and the second outer-layer portion include dielectric particles including a void therein; and
the intragranular void density in the middle portion of the inner-layer portion, or the inner-layer middle portion, defined as N [inner-layer middle portion], and intragranular void densities in the first outer-layer portion and the second outer-layer portion, defined as N [outer-layer portion], satisfy a relationship of N [inner-layer middle portion]<N [outer-layer portion].

4. The multilayer ceramic capacitor according to claim 1, wherein
a dimension of the multilayer ceramic capacitor in the length direction is about 0.2 mm or more and about 3.2 mm or less;
a dimension of the multilayer ceramic capacitor in the width direction is about 0.1 mm or more and about 2.5 mm or less; and
a dimension of the multilayer ceramic capacitor in the stacking direction is about 0.1 mm or more and about 2.5 mm or less.

5. The multilayer ceramic capacitor according to claim 1, wherein each of the dielectric particles includes a perovskite oxide as a main component.

6. The multilayer ceramic capacitor according to claim 5, wherein the perovskite oxide includes at least one of a barium titanate compound, a calcium titanate compound, or a strontium titanate compound.

7. The multilayer ceramic capacitor according to claim 5, wherein each of the dielectric particles includes at least one of a rare earth element, magnesium, manganese, iron, chromium, cobalt, nickel, silicon, aluminum, or vanadium as a secondary component.

8. The multilayer ceramic capacitor according to claim 1, wherein the plurality of dielectric particles include core-shell particles.

9. The multilayer ceramic capacitor according to claim 1, wherein a thickness of the at least one dielectric layer is about 0.6 μm or more and about 3.0 μm or less.

10. The multilayer ceramic capacitor according to claim 1, wherein a number of the at least one dielectric layer is 10 or more and 2000 or less.

11. The multilayer ceramic capacitor according to claim 1, wherein each of the at least one first inner electrode layer and the at least one second inner electrode layer includes nickel, copper, silver, palladium, a silver-palladium alloy, or gold.

12. The multilayer ceramic capacitor according to claim 1, wherein a thickness of each of the at least one first inner electrode layer and the at least one second inner electrode layer is about 0.40 μm or more and about 1.5 μm or less.

13. The multilayer ceramic capacitor according to claim 1, wherein each of the first and second outer-layer portions and the first and second side margin portions includes no inner electrode layer.

14. The multilayer ceramic capacitor according to claim 1, wherein each of the pair of outer electrodes includes a base electrode layer and a plating layer on the base electrode layer.

15. The multilayer ceramic capacitor according to claim 1, wherein a relationship of about 1.00≤D50 [inner-layer W-end portion]/D50 [inner-layer middle portion]≤about 1.17 is satisfied.

16. The multilayer ceramic capacitor according to claim 1, wherein a relationship of about 1.00≤D50 [inner-layer W-end portion]/D50 [inner-layer middle portion]≤about 1.06 is satisfied.

17. The multilayer ceramic capacitor according to claim 1, wherein D50 [inner-layer middle portion] is about 150 nm or more and about 360 nm or less.

18. The multilayer ceramic capacitor according to claim 1, wherein D50 [inner-layer W-end portion] is about 150 nm or more and about 500 nm or less.

19. The multilayer ceramic capacitor according to claim 1, wherein N [inner-layer middle portion] is more than 0 voids/μm² and about 10 voids/μm² or less.

20. The multilayer ceramic capacitor according to claim 1, wherein N [side margin portion] is about 5 voids/μm² or more and about 26 voids/μm² or less.
